(19) United States
(12) Patent Application Publication
(10) Pub. No.: US 2003/0231253 A1
(43) Pub. Date: Dec. 18, 2003

(54) Image-sensing apparatus

(75) Inventor: Tomokazu Kakumoto, Nagaokakyo-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/457,222

(22) Filed: Jun. 9, 2003

(30) Foreign Application Priority Data
Jun. 13, 2002 (JP) 2002-173077

(51) Int. Cl. H04N 5/335

(52) U.S. Cl. 348/308

(57) ABSTRACT

An image-sensing apparatus has a solid-state image-sensing device and a horizontal and a vertical scanning circuit. The solid-state image-sensing device has a plurality of pixels arranged in a matrix, and each pixel includes a photoelectric conversion element. The solid-state image-sensing device further has an adder circuit for adding together the outputs of a plurality of pixels. The horizontal and vertical scanning circuits are for reading out signals from the individual pixels. The operation of at least one of the horizontal and vertical scanning circuits is selectable between progressive scanning and interlaced scanning, and one among a plurality of units of stages that constitute that scanning circuit outputs a select signal during interlaced scanning.

This application is based on Japanese Patent Application No. 2002-173077 filed on Jun. 13, 2002, the contents of which are hereby incorporated by reference.

### BACKGROUND OF THE INVENTION

1. Field of the Invention

The present invention relates to an image-sensing apparatus, and more particularly to an image-sensing apparatus that can perform interlaced scanning.

2. Description of the Prior Art

In an image-sensing apparatus, it is common to increase the frame rate by performing interlaced scanning, i.e., by reading out pixel data every other row or every other column.

Conventionally, interlaced scanning is achieved by validating only the outputs from the desired stages of a shift register. For this reason, in interlaced scanning, to obtain the same scanning rate as when all photoelectric conversion elements are scanned, quite inconveniently, it is necessary to feed the shift register with pulses having a higher frequency than when all photoelectric conversion elements are scanned.

### SUMMARY OF THE INVENTION

An object of the present invention is to provide an image-sensing apparatus that can perform interlaced scanning at the same scanning rate as when all photoelectric conversion elements are scanned without requiring pulses having a higher frequency than when all photoelectric conversion elements are scanned.

To achieve the above object, according to one aspect of the present invention, an image-sensing apparatus is provided with a solid-state image-sensing device and a horizontal and a vertical scanning circuit. Here, the solid-state image-sensing device has a plurality of pixels arranged in a matrix, and each pixel includes a photoelectric conversion element. The solid-state image-sensing device also has an adder circuit for adding together the outputs of a plurality of pixels. The horizontal and vertical scanning circuits are for reading out signals from the individual pixels. The operation of at least one of the horizontal and vertical scanning circuits is selectable between progressive scanning and interlaced scanning, and one at a time among a plurality of units of stages that constitute that scanning circuit outputs a select signal during interlaced scanning.

According to another aspect of the present invention, an image-sensing apparatus is provided with a solid-state image-sensing device and a scanning circuit. Here, the solid-state image-sensing device has a plurality of pixels, and each pixel includes a photoelectric conversion element. The scanning circuit is for scanning the pixels. The operation of the scanning circuit is selectable between progressive scanning and interlaced scanning, and interlaced scanning is switchable between a first mode and a second mode that differ in the number of lines skipped by interlacing.

According to still another aspect of the present invention, an image-sensing apparatus is provided with a solid-state image-sensing device and a scanning circuit. Here, the solid-state image-sensing device has a plurality of pixels arranged in a matrix, and each pixel includes a photoelectric conversion element. The scanning circuit is for scanning the pixels. The scanning circuit performs scanning at a frequency equal to or higher than twice the scanning signal frequency. The operation of the scanning circuit is selectable between progressive scanning and interlaced scanning. Interlaced scanning is performed at a higher frame rate than progressive scanning, or alternatively interlaced scanning is performed with a lower scanning pulse frequency than progressive scanning.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram of an image-sensing apparatus according to the invention;

FIG. 2 is a block diagram of the X-Y address area sensor shown in FIG. 1;

FIG. 3 is a circuit diagram of the vertical scanning circuit shown in FIG. 2;

FIG. 4 is a circuit diagram of the flip-flop shown in FIG. 3;

FIG. 5 is a circuit diagram of the horizontal scanning circuit shown in FIG. 2;

FIG. 6 is a circuit diagram of the flip-flop shown in FIG. 5;

FIG. 7 is a timing chart of the signals generated by the timing generator shown in FIG. 1;

FIG. 8 is a block diagram of the scan mode switcher shown in FIG. 1;

FIGS. 9A to 9C are timing charts of the signals fed to the vertical scanning circuit shown in FIG. 2;

FIGS. 10A to 10C are timing charts of the signals fed to the horizontal scanning circuit shown in FIG. 2;

FIG. 11 is a block diagram of another image-sensing apparatus according to the invention;

FIG. 12 is a block diagram of the X-Y address area sensor shown in FIG. 11;

FIG. 13 is a circuit diagram of the vertical scanning circuit shown in FIG. 12;

FIG. 14 is a circuit diagram of the flip-flop shown in FIG. 13;

FIG. 15 is a circuit diagram of the horizontal scanning circuit shown in FIG. 12;

FIG. 16 is a circuit diagram of the flip-flop shown in FIG. 15;

FIG. 17 is a block diagram of the scan mode switcher shown in FIG. 11;

FIGS. 18A to 18C are timing charts of the signals fed to the vertical scanning circuit shown in FIG. 12;

FIGS. 19A to 19C are timing charts of the signals fed to the horizontal scanning circuit shown in FIG. 12;

FIG. 20 is a block diagram of still another image-sensing apparatus according to the invention;

FIG. 21 is a block diagram of the X-Y address area sensor shown in FIG. 20;

FIG. 22 is a circuit diagram of the vertical scanning circuit shown in FIG. 21;

FIG. 23 is a circuit diagram of the flip-flop shown in FIG. 22;

FIG. 24 is a circuit diagram of the horizontal scanning circuit shown in FIG. 21;

FIG. 25 is a circuit diagram of the flip-flop shown in FIG. 24;

FIG. 26 is a block diagram of the scan mode switcher shown in FIG. 20;

FIGS. 27A to 27C are timing charts of the signals fed to the vertical scanning circuit shown in FIG. 21;

FIGS. 28A to 28C are timing charts of the signals fed to the horizontal scanning circuit shown in FIG. 21;

FIG. 29 is a circuit diagram of each of the pixels constituting the sensing portion shown in FIGS. 2, 12, and 21;

FIG. 30 is a timing chart of the relevant signals during detection of pixel-to-pixel variations;

FIG. 31 is a diagram showing a first circuit configuration for interconnection between pixels;

FIG. 32 is a diagram showing a second circuit configuration for interconnection between pixels;

FIG. 33 is a diagram showing a third circuit configuration for interconnection between pixels;

### DESCRIPTION OF THE PREFERRED EMBODIMENTS

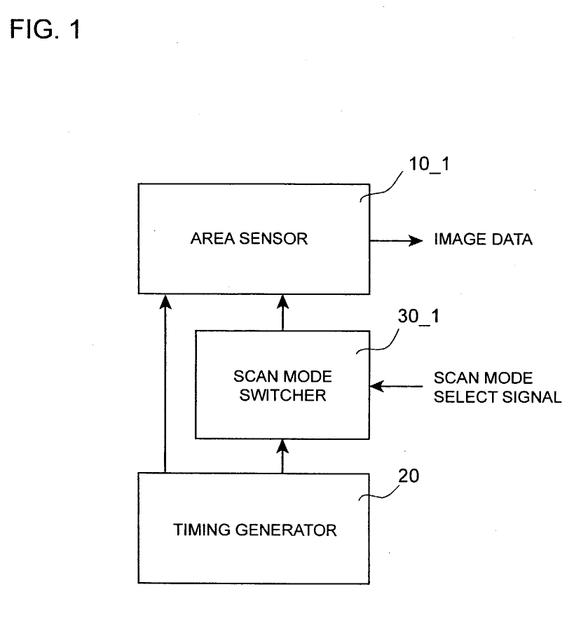

Hereinafter, embodiments of the present invention will be described with reference to the drawings. FIG. 1 is a block diagram of an image-sensing apparatus according to the invention. In FIG. 1, reference numeral 10_1 represents an X-Y address area sensor, reference numeral 20 represents a timing generator, and reference numeral 30_1 represents a scan mode switcher.

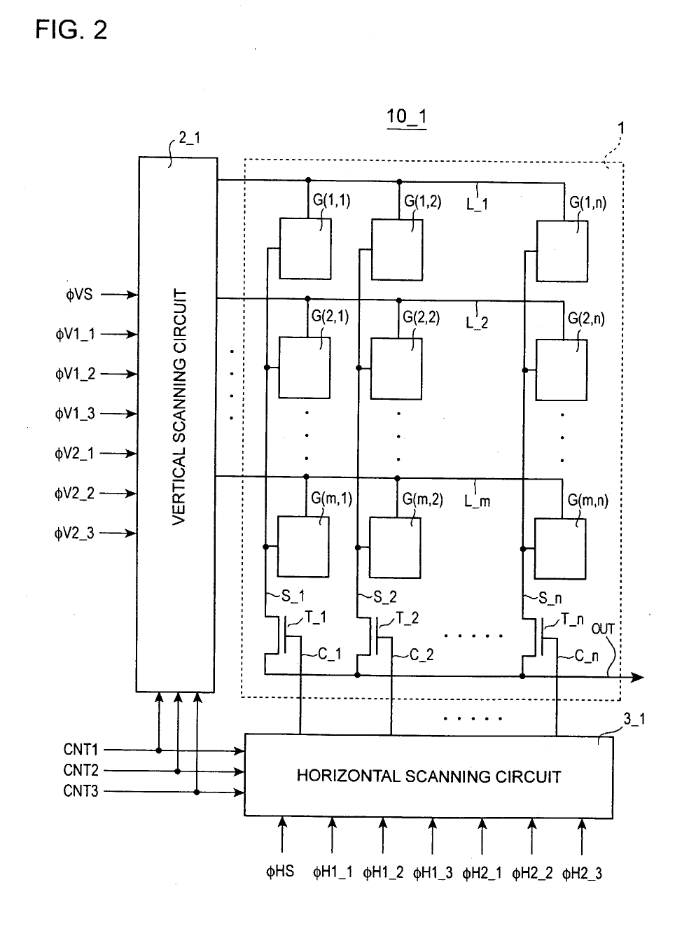

FIG. 2 is a block diagram of the X-Y address area sensor 10_1. As shown in FIG. 2, the X-Y address area sensor 10_1 includes a sensing portion 1 having a plurality of pixels G(1, 1), G(1, 2), . . . , G(1, n), G(2, 1), G(2, 2), . . . G(2, n), . . . , G(m, 1), G(m, 2), . . . , and G(m, n), each having a photoelectric conversion element, arranged in a matrix-like formation, a vertical scanning circuit 2_1 for vertically scanning the sensing portion 1, and a horizontal scanning circuit 3_1 for horizontally scanning the sensing portion 1. Here, m and n each represent a positive integral number.

The sensing portion 1 includes m vertical scanning lines L_1, L_2, . . . , and L_m; n signal lines S_1, S_2, . . . , and S_n; n horizontal scanning lines C_1, C_2, . . . , and C_n, n MOS transistors T_1, T_2, . . . , and T_n; and a readout line OUT. Let p be an integral number fulfilling 1≦p≦m and q be an integral number fulfilling 1≦q≦n. Then, the pixel G(p, q) is connected to the vertical scanning line L_p and to the signal line S_q. Moreover, the signal line S_q is connected, through the drain-source channel of the corresponding transistor T_q, commonly to the readout line OUT. Furthermore, the transistor T_q has its gate connected to the horizontal scanning line C_q.

In the sensing portion 1, when the vertical scanning line L_p is driven with a low-level direct-current voltage, the data of the pixels G(p, 1), G(p, 2), . . . , and G(p, n) are delivered to the signal lines S_1, S_2, . . . , and S_n, respectively. On the other hand, when the horizontal scanning line C_q is driven with a low-level direct-current voltage, the transistor T_q is turned ON, and the data on the signal line S_q are fed out via the readout line OUT.

The vertical scanning circuit 2_1 receives a vertical scanning start signal φVS from the timing generator 20, and receives six vertical scanning signals φV1_{—}1, φV1_{—}2, φV1_{—}3, φV2_{—}1, φV2_{—}2, and φV2_{—}3 and signals CNT1, CNT2, and CNT3 from the scan mode switcher 30_1.

The horizontal scanning circuit 3_1 receives a horizontal scanning start signal φHS from the timing generator 20, and receives six horizontal scanning signals φH1_{—}1, φH1_{—}2, φH1_{—}3, φH2_{—}1, φH2_{—}2, and φH2_{—}3 and signals CNT1, CNT2, and CNT3 from the scan mode switcher 30_1.

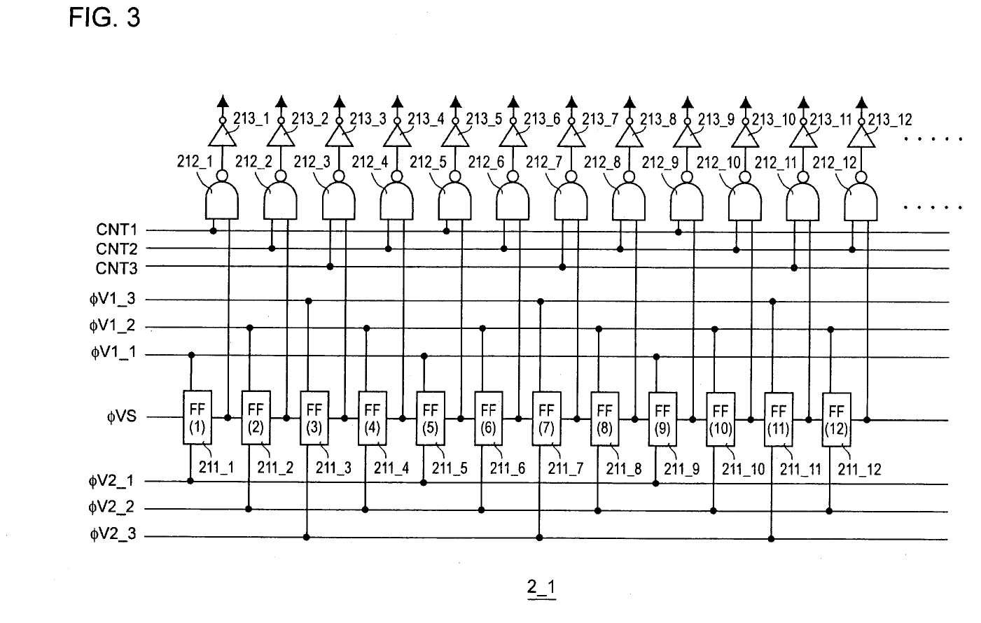

FIG. 3 shows the circuit configuration of the vertical scanning circuit 2_1. In FIG. 3, reference numerals 211_1, 211_2, . . . represent flip-flops, reference numerals 212_1, 212_2, . . . represent NAND gates, and reference numerals 213_1, 213_2, . . . represent inverters. There are provided m of each of these flip-flops, NAND gates, and inverters.

The flip-flops 211_1, 211_2, . . . are latches of the type that, while a strobe signal is active, outputs the input thereto intact and that, when the strobe signal becomes inactive, holds and outputs the immediately previous input thereto. Incidentally, this type of latch is called a G latch. The flip-flops 211_1, 211_2, . . . are connected in series to form a shift register.

The flip-flop 211_1 receives the vertical scanning start signal φVS. The flip-flops 211_2, 211_3, . . . and, 211_{—}m receive the outputs of the flip-flops 21_1, 211_2, . . . , and 211_(m−1), respectively.

The NAND gates 212_1, 212_5, 212_9, . . . receive at one input terminal thereof the signal CNT1, and receive at the other input terminal thereof the outputs of the flip-flops 211_1, 211_5, 211_9, . . . , respectively.

The NAND gates 212_2, 212_4, 212_6, . . . receive at one input terminal thereof the signal CNT2, and receive at the other input terminal thereof the outputs of the flip-flops 211_2, 211_4, 211_6, . . . , respectively.

The NAND gates 212_3, 212_7, 212_11, . . . receive at one input terminal thereof the signal CNT3, and receive at the other input terminal thereof the outputs of the flip-flops 211_3, 211_7, 211_11, . . . , respectively.

The output of the NAND gate 212_{—}p is fed to the inverter 213_{—}p. With the output of the inverter 213_{—}p, the vertical scanning line L_p of the sensing portion 1 is driven.

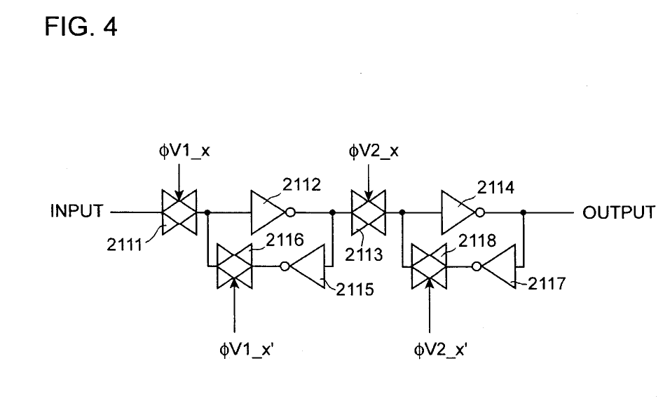

As shown in FIG. 4, the flip-flops 211_1, 211_2, . . . , and 211_{—}m each include an analog switch 2111, an inverter 2112, an analog switch 2113, inverters 2114 and 2115, and an analog switch 2116, an inverter 2117, and an analog switch 2118.

A signal fed into the flip-flop 211_{—}p is fed through the analog switch 2111 to the inverter 2112. The output of the inverter 2112 is fed through the analog switch 2113 to the inverter 2114, and is fed also to the inverter 2115. The output of the inverter 2115 is fed through the analog switch 2116 to the inverter 2112. The output of the inverter 2114 is used to drive the vertical scanning line L_p of the sensing portion 1, and is fed to the inverter 2117. The output of the inverter 2117 is fed through the analog switch 2118 to the inverter 2114.

In the flip-flops 211_1, 211_5, 211_9, . . . , the analog switch 2111 is turned ON and OFF by the vertical scanning signal φV1_1 so as to be ON when the vertical scanning signal φV1_{—}1 is high and OFF when the vertical scanning signal φV1_{—}1 is low.

In the flip-flops 211_1, 211_5, 211_9, . . . , the analog switch 2116 is turned ON and OFF by the inverted signal φV1_{—}1′ of the vertical scanning signal φV1_{—}1 so as to be OFF when the vertical scanning signal φV1_{—}1 is high and ON when the vertical scanning signal φV1_{—}1 is low.

In the flip-flops 211_1, 211_5, 211_9, . . . , the analog switch 2113 is turned ON and OFF by the vertical scanning signal φV2_{—}1 so as to be ON when the vertical scanning signal φV2_{—}1 is high and OFF when the vertical scanning signal φV2_{—}1 is low.

In the flip-flops 211_1, 211_5, 211_9, . . . , the analog switch 2118 is turned ON and OFF by the inverted signal φV2_{—}1′ of the vertical scanning signal φV2_{—}1 so as to be OFF when the vertical scanning signal φV2_{—}1 is high and ON when the vertical scanning signal φV2_{—}1 is low.

In the flip-flops 211_2, 211_4, 211_6, . . . , the analog switch 2111 is turned ON and OFF by the vertical scanning signal φV1_{—}2 so as to be ON when the vertical scanning signal φV1_{—}2 is high and OFF when the vertical scanning signal φV1_{—}2 is low.

In the flip-flops 211_2, 211_4, 211_6, . . . , the analog switch 2116 is turned ON and OFF by the inverted signal φV1_{—}2′ of the vertical scanning signal φV1_{—}2 so as to be OFF when the vertical scanning signal φV1_{—}2 is high and ON when the vertical scanning signal φV1_{—}2 is low.

In the flip-flops 211_2, 211_4, 211_6, . . . , the analog switch 2113 is turned ON and OFF by the vertical scanning signal φV2_{—}2 so as to be ON when the vertical scanning signal φV2_{—}2 is high and OFF when the vertical scanning signal φV2_{—}2 is low.

In the flip-flops 211_2, 211_4, 211_6, . . . , the analog switch 2118 is turned ON and OFF by the inverted signal φV2_{—}2′ of the vertical scanning signal φV2_{—}2 so as to be OFF when the vertical scanning signal φV2_{—}2 is high and ON when the vertical scanning signal φV2_{—}2 is low.

In the flip-flops 211_3, 211_7, 211_11, . . . , the analog switch 2111 is turned ON and OFF by the vertical scanning signal φV1_{—}3 so as to be ON when the vertical scanning signal φV1_{—}3 is high and OFF when the vertical scanning signal φV1_{—}3 is low.

In the flip-flops 211_3, 211_7, 211_11, . . . , the analog switch 2116 is turned ON and OFF by the inverted signal φV1_{—}3′ of the vertical scanning signal φV1_{—}3 so as to be OFF when the vertical scanning signal φV1_{—}3 is high and ON when the vertical scanning signal φV1_{—}3 is low.

In the flip-flops 211_3, 211_7, 211_11, . . . , the analog switch 2113 is turned ON and OFF by the vertical scanning signal φV2_{—}3 so as to be ON when the vertical scanning signal φV2_{—}3 is high and OFF when the vertical scanning signal φV2_{—}3 is low.

In the flip-flops 211_3, 211_7, 211_11, . . . , the analog switch 2118 is turned ON and OFF by the inverted signal φV2_{—}3′ of the vertical scanning signal φV2_{—}3 so as to be OFF when the vertical scanning signal φV2_{—}3 is high and ON when the vertical scanning signal φV2_{—}3 is low.

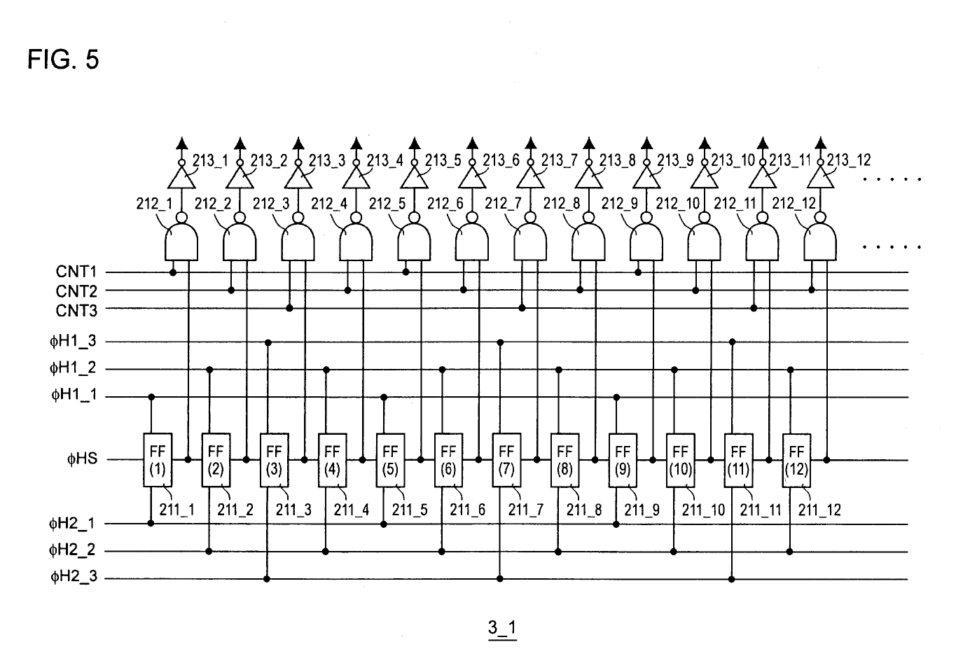

FIG. 5 shows the circuit configuration of the horizontal scanning circuit 3_1. As shown in FIG. 5, the horizontal scanning circuit 3_1 has largely the same configuration as the vertical scanning circuit 2_1. One difference is that the vertical scanning start signal φVS and the vertical scanning signals φV1_{—}1, φV1_{—}2, φV1_{—}3, φV2_{—}2, φV2_{—}2, and φV2_{—}3 used in the latter are here replaced with the horizontal scanning start signal φHS and the horizontal scanning signals φH1_{—}1, φH1_{—}2, φH1_{—}3, φH2_1, φH2_{—}2, and φH2_{—}3, respectively. The horizontal scanning lines C_q of the sensing portion 1 are driven with the outputs of the inverters 213_{—}q constituting the horizontal scanning circuit 3_1.

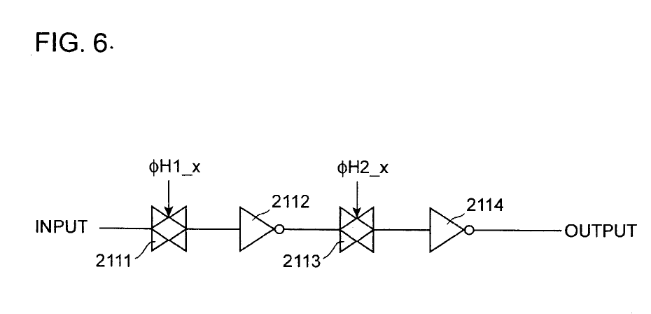

Another difference is that, as shown in FIG. 6, the flip-flops 211_1, 211_2, . . . , and 211_{—}m used in the horizontal scanning circuit 3_1 lack the inverter 2115, analog switch 2116, inverter 2117, and analog switch 2118 as compared with the flip-flops 211_1, 211_2, . . . , and 211_{—}m used in the vertical scanning circuit 2_1. This is because the horizontal scanning signals have higher frequencies than the vertical scanning signals, and therefore the omission of the inverter 2115, analog switch 2116, inverter 2117, and analog switch 2118 does not affect the operation required here.

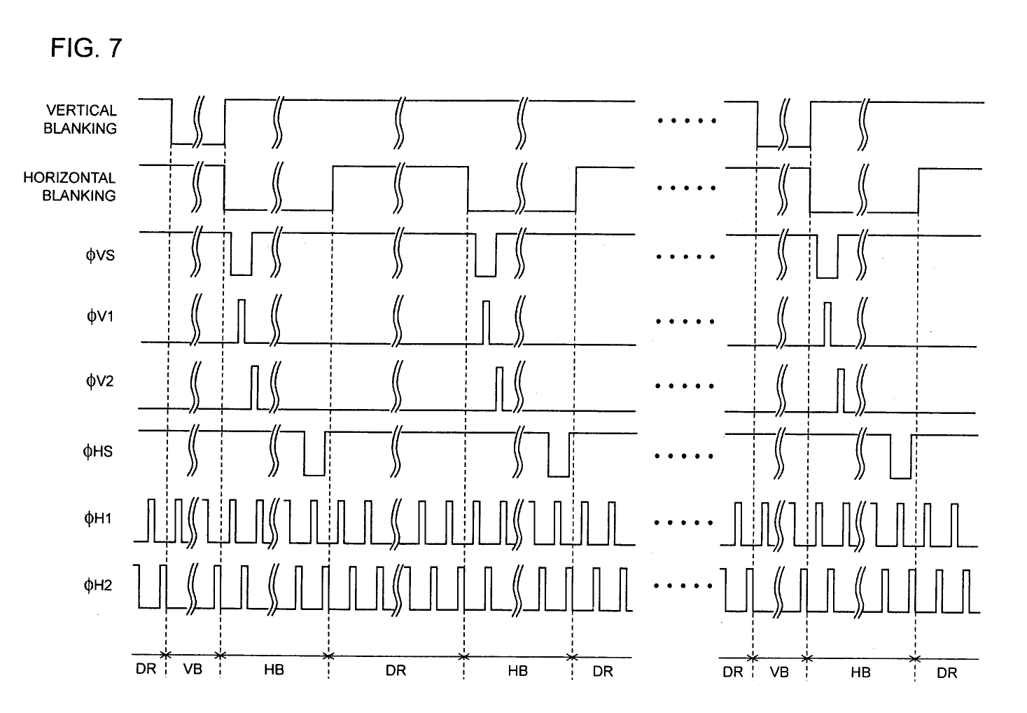

The timing generator 20 generates a vertical scanning start signal φVS, a first vertical scanning signal φV1, a second vertical scanning signal φV2, a horizontal scanning start signal φHS, a first horizontal scanning signal φH1, and a second horizontal scanning signal φH2 shown in a timing chart in FIG. 7. In FIG. 7, reference symbol VB represents a vertical blanking period, reference symbol HB represents a horizontal blanking period, and reference symbol DR represents a data readout period.

In the vertical scanning start signal φVS, a pulse appears during the horizontal blanking period HB immediately following a vertical blanking period VB. In the first and second vertical scanning signals φV1and φV2, a pulse appears during each horizontal blanking period. The pulses that appear in the vertical scanning start signal φVS are low, and the pulses that appear in the first and second vertical scanning signals φV1and φV2are high.

In the horizontal scanning start signal φHS, a pulse appears immediately before each horizontal blanking period HB ends. In the first and second horizontal scanning signals φH1 and φH2, pulses appear at predetermined time intervals all the time. Within a horizontal blanking period HB, one pulse appears in each of the first and second horizontal scanning signals φH1 an φH2 during the period after a pulse appears in the horizontal scanning start signal φHS until the end of that horizontal blanking period HB. The pulses that appear in the horizontal scanning start signal φHS are low, and the pulses that appear in the first and second horizontal scanning signals φH1 an φH2 are high.

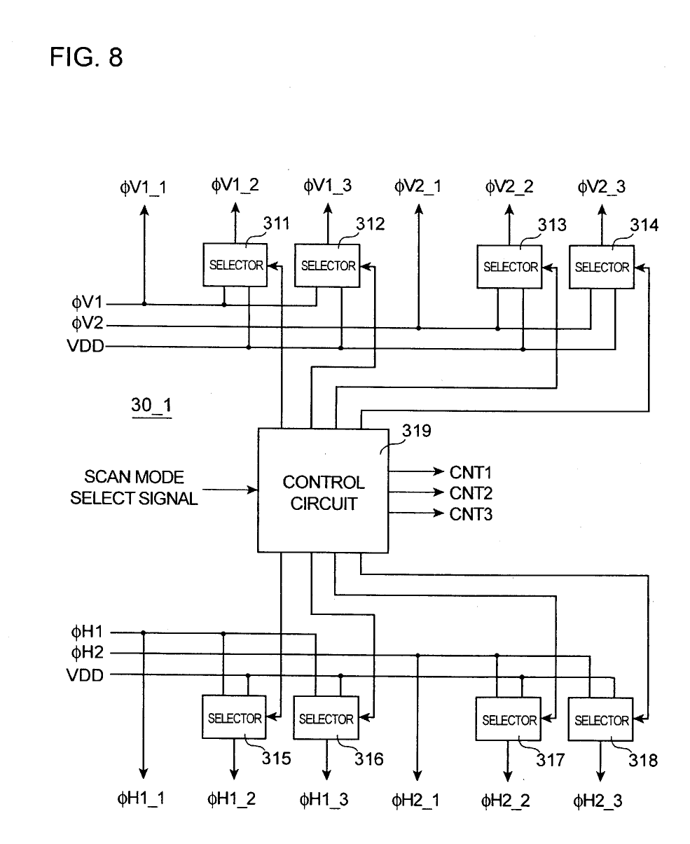

FIG. 8 shows the circuit configuration of the scan mode switcher 30_1. The scan mode switcher 30_1 includes selectors 311, 312, 313, 314, 315, 316, 317, and 318 and a control circuit 319. The scan mode switcher 30_1 receives the first vertical scanning signal φV1, second vertical scanning signal φV2, first horizontal scanning signal φH1, and second horizontal scanning signal φH2 output from the timing generator 20.

The selectors 311 and 312 choose and output one of the first vertical scanning signal φV1and a high-level direct-current voltage VDD, whichever the control circuit 319 instructs them to choose. The selectors 313 and 314 choose and output one of the second vertical scanning signal φV2and the high-level direct-current voltage VDD, whichever the control circuit 319 instructs them to choose.

The selectors 315 and 316 choose and output one of the first horizontal scanning signal φH1 and the high-level direct-current voltage VDD, whichever the control circuit 319 instructs them to choose. The selectors 317 and 318 choose and output one of the second horizontal scanning signal φH2 and the high-level direct-current voltage VDD, whichever the control circuit 319 instructs them to choose.

From the scan mode switcher 30_1, the first vertical scanning signal φV1is output as a vertical scanning signal φV1_{—}1, the signal output from the selector 311 is output as a vertical scanning signal φV1_{—}2, the signal output from the selector 312 is output as a vertical scanning signal φV1_{—}3, the second vertical scanning signal φV2 is output as a vertical scanning signal φV2_{—}1, the signal output from the selector 313 is output as a vertical scanning signal φV2_{—}2, the signal output from the selector 314 is output as a vertical scanning signal φV2_{—}3.

From the scan mode switcher 30_1, the first horizontal scanning signal φH1 is output as a horizontal scanning signal φH1_{—}1, the signal output from the selector 315 is output as a horizontal scanning signal φH1_{—}2, the signal output from the selector 316 is output as a horizontal scanning signal φH1_{—}3, the second horizontal scanning signal φH2 is output as a horizontal scanning signal φH2_{—}1, the signal output from the selector 317 is output as a horizontal scanning signal φH2_{—}2, the signal output from the selector 318 is output as a horizontal scanning signal φH2_{—}3.

When a first scan mode is requested by a scan mode select signal, the control circuit 319 controls the selectors 311, 312, 313, 314, 315, 316, 317, and 318 in such a way that the selectors 311 and 312 choose the first vertical scanning signal φV1, that the selectors 313 and 314 choose the second vertical scanning signal φV2, that the selectors 315 and 316 choose the first horizontal scanning signal φH1, and that the selectors 317 and 318 choose the second horizontal scanning signal φH2. The control circuit 319 also generates and outputs signals CNT1, CNT2, and CNT3. When the first scan mode is requested by the scan mode select signal, the control circuit 319 turns the signals CNT1, CNT2, and CNT3 high.

When a second scan mode is requested by the scan mode select signal, the control circuit 319 controls the selectors 311, 312, 313, 314, 315, 316, 317, and 318 in such a way that the selector 311 chooses the high-level direct-current voltage VDD, that the selector 312 chooses the first vertical scanning signal φV1, that the selector 313 chooses the high-level direct-current voltage VDD, that the selector 314 chooses second vertical scanning signal φV2, that the selector 315 chooses the high-level direct-current voltage VDD, that the selector 316 chooses the first horizontal scanning signal φH1, that the selector 317 chooses the high-level direct-current voltage VDD, and that the selector 318 chooses the second horizontal scanning signal φH2. Moreover, when the second scan mode is requested by the scan mode select signal, the control circuit 319 turns the signal CNT1 high, the signal CNT2 low, and the signal CNT3 high.

When a third scan mode is requested by the scan mode select signal, the control circuit 319 controls the selectors 311, 312, 313, 314, 315, 316, 317, and 318 in such a way that the selectors 311, 312, 313, 314, 315, 316, 317, and 318 choose the high-level direct-current voltage VDD. Moreover, when the third scan mode is requested by the scan mode select signal, the control circuit 319 turns the signal CNT1 high and the signals CNT2 and CNT3 low.

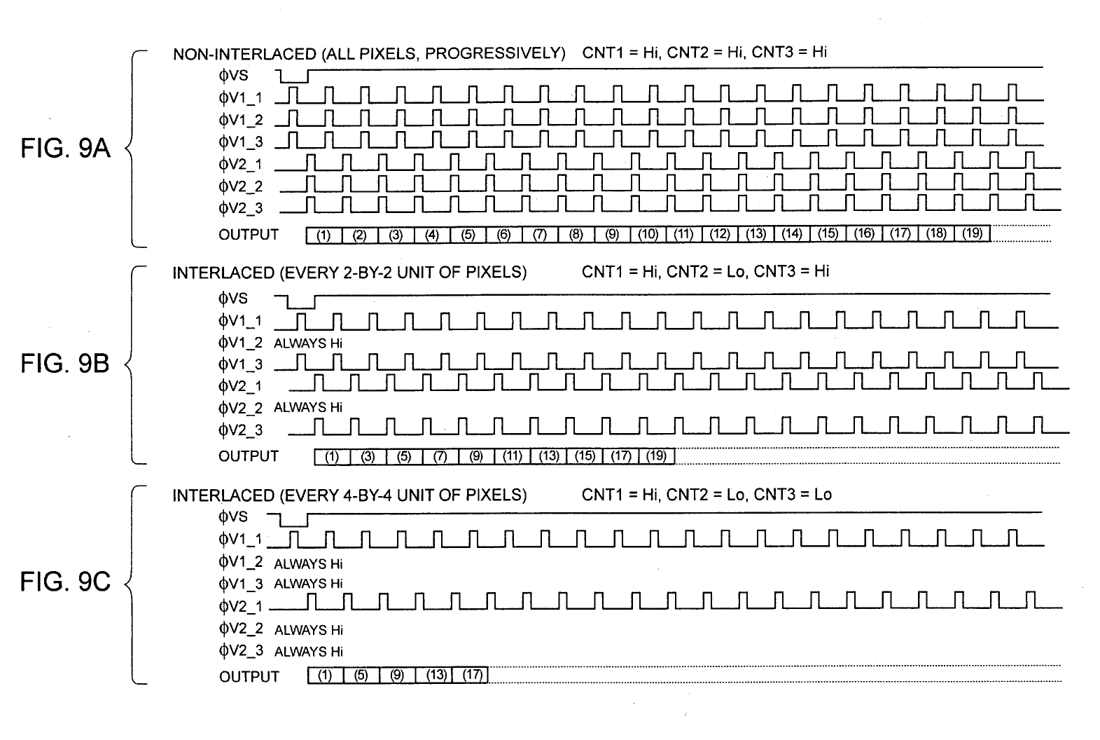

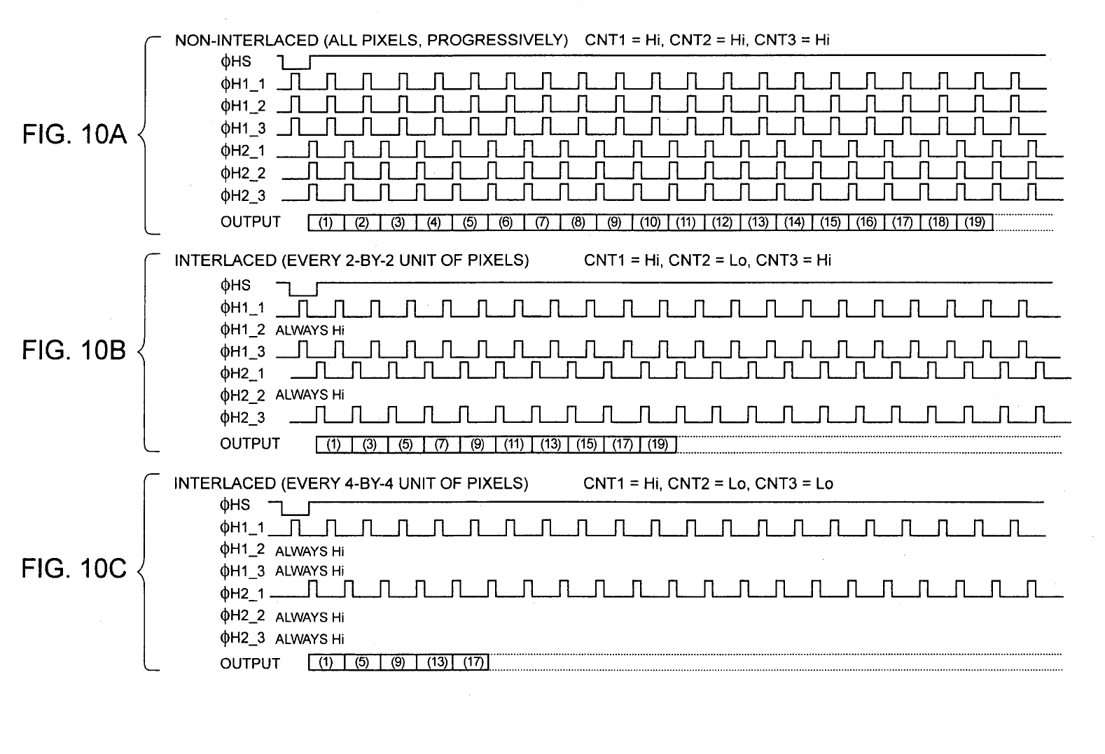

With the individual circuit blocks configured as described above, in the first scan mode, the vertical scanning start signal φVS and the vertical scanning signals φV1_{—}1, φV1_{—}2, φV1_{—}3, φV2_{—}1, φV2_{—}2, and φV2_{—}3 behave as shown in a timing chart in FIG. 9A. Thus, the pixels of all the rows of the sensing portion 1 are scanned progressively, starting with the first row. On the other hand, the horizontal scanning start signal φHS and the horizontal scanning signals φH1_{—}1, φH1_{—}2, φH1_{—}3, φH2_{—}1, φH2_{—}2, and φH2₁₃ 3 behave as shown in a timing chart in FIG. 10A. Thus, the pixels of all the columns of the sensing portion 1 are scanned progressively, starting with the first column. As a result, in the first scan mode, the data of all the pixels of the sensing portion 1 are read out.

In the second scan mode, the vertical scanning start signal φVS and the vertical scanning signals φV1_{—}1, φV1_{—}2, φV1_{—}3, φV2_{—}1, φV2_{—}2, and φV2_{—}3 behave as shown in a timing chart in FIG. 9B. Thus, the pixels of the sensing portion 1 are scanned in the following order: the pixels in the first row, then those in the third row, then those in the fifth row, and so forth. On the other hand, the horizontal scanning start signal φHS and the horizontal scanning signals φH1_{—}1, φH1_{—}2, φH1_{—}3, φH2_{—}1, φH2_{—}2, and φH2_{—}3 behave as shown in a timing chart in FIG. 10B. Thus, the pixels of the sensing portion 1 are scanned in the following order: the pixels in the first column, then those in the third column, then those in the fifth column, and so forth. As a result, in the second scan mode, the data of the pixels that are located simultaneously in the odd-numbered rows and in the odd-numbered columns of the sensing portion 1 are read out.

In the third scan mode, the vertical scanning start signal φVS and the vertical scanning signals φV1_{—}1, φV1_{—}2, φV1_{—}3, φV2_{—}1, φV2_{—}2, and φV2_{—}3 behave as shown in a timing chart in FIG. 9C. Thus, the pixels of the sensing portion 1 are scanned in the following order: the pixels in the first row, then those in the fifth row, then those in the ninth row, and so forth. On the other hand, the horizontal scanning start signal φHS and the horizontal scanning signals φH1_{—}1, φH1_{—}2, φH1_{—}3, φH2_{—}1, φH2_{—}2, and φH2_{—}3 behave as shown in a timing chart in FIG. 10C. Thus, the pixels of the sensing portion 1 are scanned in the following order: the pixels in the first column, then those in the fifth column, then those in the ninth column, and so forth. As a result, in the third scan mode, the data of the pixels that are located simultaneously in the (4X−3)th rows and in the (4Y−3)th columns of the sensing portion 1 are read out. Here, X and Y each represent a positive integral number.

In this way, in the first embodiment, interlaced scanning is possible. The scanning circuit is composed of G latch type flip-flops, and, for these flip-flops, a plurality of lines through which to feed them with strobe signals (signals that make them take in data) so that each flip-flop is fed with a strobe signal through one of those lines that corresponds to that flip-flop. Thus, by applying scanning pulses to the lines through which strobe signals are fed to the flip-flops corresponding to the pixels that need to be scanned, and by applying, instead of scanning pluses, a direct-current voltage, i.e., a always active signal, to the lines through which strobe signals are fed to the flip-flops corresponding to the pixels that do not need to be scanned, it is possible to perform interlaced scanning. In addition, interlaced scanning can be performed at the same scanning rate as when all photoelectric conversion elements are scanned without increasing the frequency of scanning pulses than when all photoelectric conversion elements are scanned.

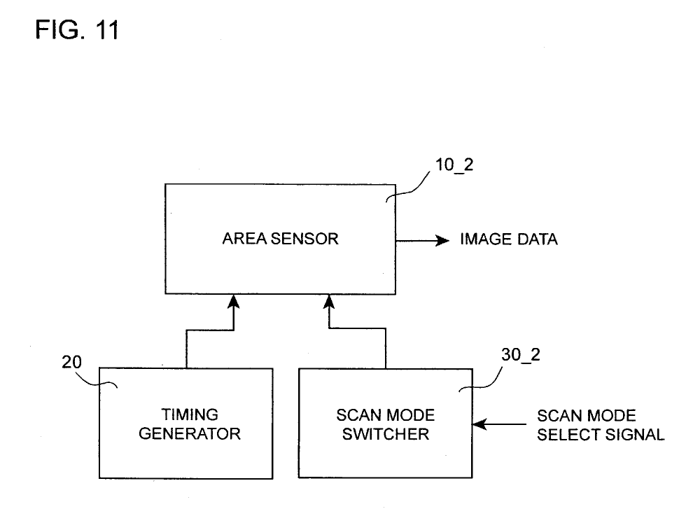

FIG. 11 is a block diagram of another image-sensing apparatus incorporating a scanning circuit according to the invention. In FIG. 11, reference numeral 10_2 represents an X-Y address area sensor, reference numeral 20 represents a timing generator, and reference numeral 30_2 represents a scan mode switcher. The timing generator 20 here is the same as in the first embodiment, and therefore its descriptions will not be repeated.

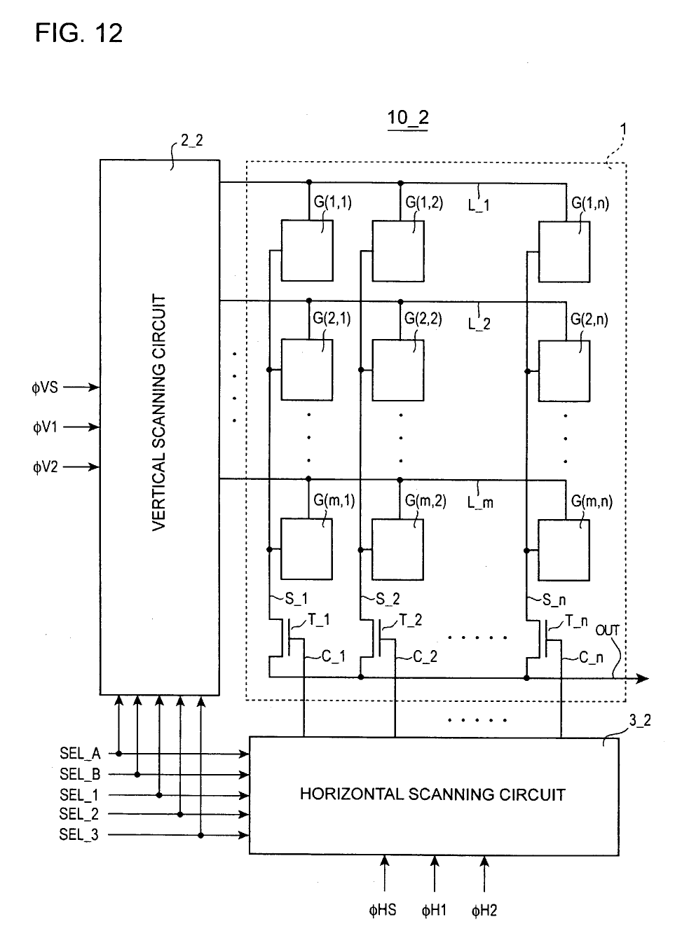

FIG. 12 is a block diagram of the X-Y address area sensor 10_2. As shown in FIG. 12, the X-Y address area sensor 10_2 includes a sensing portion 1, a vertical scanning circuit 2_2 for vertically scanning the sensing portion 1, and a horizontal scanning circuit 3_2 for horizontally scanning the sensing portion 1. The sensing portion 1 here is the same as in the first embodiment, and therefore its descriptions will not be repeated.

The vertical scanning circuit 2_2 receives a vertical scanning start signal φVS, a first vertical scanning signal φV1, and a second vertical scanning signal φV2 from the timing generator 20, and receives signals SEL_A, SEL_B, SEL_{—}1, SEL_2, and SEL_3 from the scan mode switcher 30_2.

The horizontal scanning circuit 3_2 receives a horizontal scanning start signal φHS, a first horizontal scanning signal φH1, and a second horizontal scanning signal φH2 from the timing generator 20, and receives signals SEL_A, SEL_B, SEL_{—}1, SEL_2, and SEL_3 from the scan mode switcher 30_2.

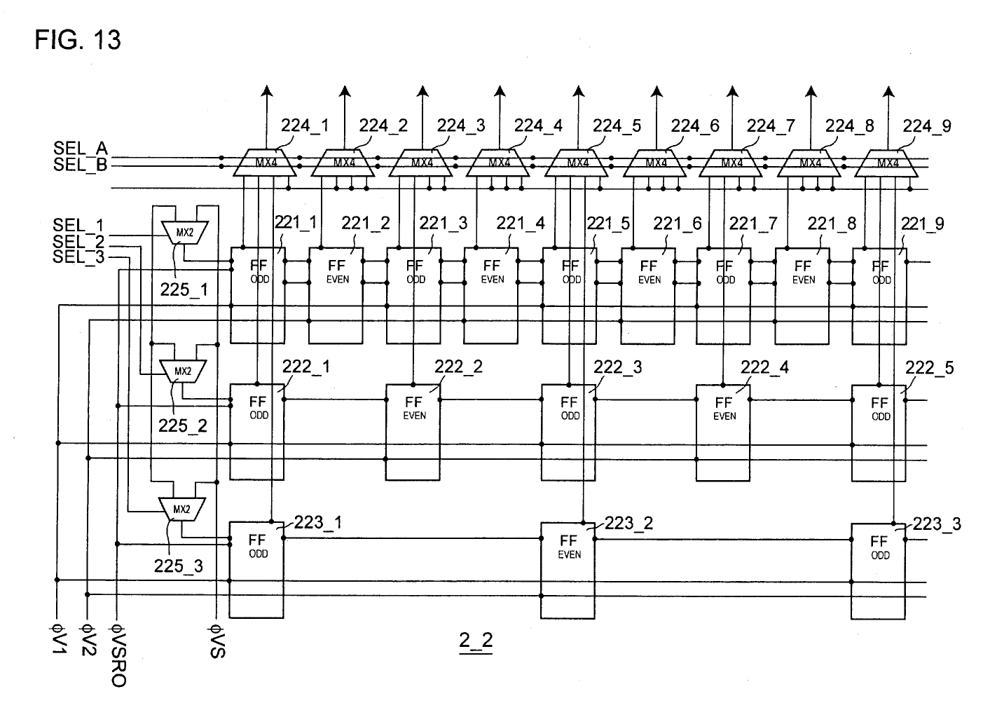

FIG. 13 shows the circuit configuration of the vertical scanning circuit 2_2. In FIG. 13, reference numerals 221_1, 221_2, . . . , 222_1, 222_2, . . . 223_1, 223_2, . . . represent flip-flops, reference numerals 224_1, 224_2, . . . represent selectors each having four input terminals, and reference numerals 225_1, 225_2, and 225_3 represent selectors each having two input terminals.

The flip-flops 221_1, 221_2, . . . are connected in series to form a shift register. The flip-flops 222_1, 222_2, . . . are connected in series to form a shift register. The flip-flops 223_1, 223_2, . . . are connected in series to form a shift register.

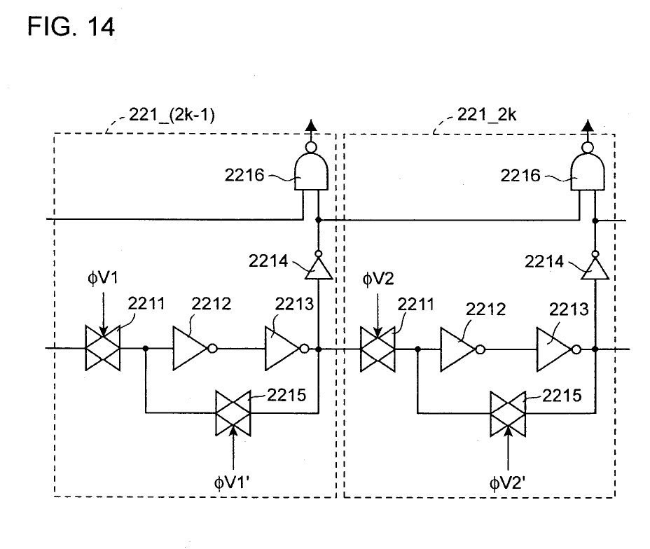

The flip-flops 221_1, 221_2, . . . are all G latch type flip-flops, and each include, as shown in FIG. 14, an analog switch 2211, inverters 2212, 2213, and 2214, an analog switch 2215, and a NAND gate 2216. In the flip-flop 221_1, the signal output from the selector 225_1 is fed through the analog switch 2211 to the inverter 2212. In the flip-flops 221_{—}p other than the flip-flop 221_1, the output of the inverter 2213 of the flip-flop 221_(p−1) is fed through the analog switch 2211 to the inverter 2212. The output of the inverter 2212 is fed to the inverter 2213. The output of the inverter 2213 is fed to the inverter 2214, and is also fed through the analog switch 2215 to the inverter 2212.

Let k be a positive integral number. Then, in the flip-flop 211_(2k−1), the analog switch 2211 is turned ON and OFF by the first vertical scanning signal φV1 and the analog switch 2215 is turned ON and OFF by the inverted signal φV1′ of the first vertical scanning signal φV1 in such a way that the analog switches 2211 and 2215 are, when the first vertical scanning signal φV1 is high, ON and OFF, respectively, and, when the first vertical scanning signal φV1 is low, OFF and ON, respectively.

On the other hand, in the flip-flop 211_2k, the analog switch 2211 is turned ON and OFF by the second vertical scanning signal φV2 and the analog switch 2215 is turned ON and OFF by the inverted signal φV2′ of the second vertical scanning signal φV2 in such a way that the analog switches 2211 and 2215 are, when the second vertical scanning signal φV2 is high, ON and OFF, respectively, and, when the second vertical scanning signal φV2 is low, OFF and ON, respectively.

In the flip-flop 221_1, the NAND gate 2216 receives at one input terminal thereof the output of the inverter 2214, and receives at the other input terminal thereof the inverted signal φVSR0 of the vertical scanning start signal φVS. In the flip-flops 221_{—}p other than the flip-flop 221_1, the NAND gate 2216 receives at one input terminal thereof the output of the inverter 2214, and receives at the other input terminal thereof the output of the inverter 2214 of the flip-flop 221_(p−1).

The flip-flops 222_1, 222_2, . . . and the flip-flops 223_1, 223_1, . . . are configured largely in the same manner as the flip-flops 221_1, 221_2, . . . . Only differences are that, in the flip-flop 222_1, the signal output from the selector 225_2 is fed through the analog switch 2211 to the inverter 2212 and that, in the flip-flop 223_1, the signal output from the selector 225_3 is fed through the analog switch 2211 to the inverter 2212.

The selectors 224_1, 224_5, 224_9, . . . , i.e., the selectors 224_(4k−3), each receive at the first input terminal thereof the output of the NAND gate 2216 of the flip-flop 221_(4k−3), receive at the second input terminal thereof the output of the NAND gate 2216 of the flip-flop 222_(2k−1), receive at the third input terminal thereof the output of the NAND gate 2216 of the flip-flop 223_{—}k, and receive at the fourth input terminal thereof a high-level direct-current voltage VDD.

The selectors 224_2, 224_4, 224_6, . . . , i.e., the selectors 224_2k, each receive at the first input terminal thereof the output of the NAND gate 2216 of the flip-flop 221_2k, and receive at the second, third, and fourth input terminals thereof the high-level direct-current voltage VDD.

The selectors 224_3, 224_7, 224_1 1, i.e., the selectors 224_(4k−1), each receive at the first input terminal thereof the output of the NAND gate 2216 of the flip-flop 221_(4k−1), receive at the second input terminal thereof the output of the NAND gate 2216 of the flip-flop 222_2k, and receive at the third and fourth input terminals thereof the high-level direct-current voltage VDD.

The selector 224_{—}p selects and outputs one of the four inputs thereto according to the signals SEL_A and SEL_B. Superficially, the selector 224_{—}p outputs the signal fed to the first input terminal thereto when the signals SEL_A and SEL_B are both low, outputs the signal fed to the second input terminal thereto when the signal SEL_A is high and the signal SEL_B is low, outputs the signal fed to the third input terminal thereto when the signal SEL_A is low and the signal SEL_B is high, and outputs the signal fed to the fourth input terminal thereto when the signals SEL_A and SEL_B are both high. With the outputs of the selector 224_{—}p, the vertical scanning line L_p of the sensing portion 1 is driven.

The selectors 225_1, 225_2, and 225_3 each receive at the first input terminal thereof the vertical scanning start signal φVS, and receive at the second input terminal thereof the high-level direct-current voltage VDD. The selectors 225_1, 225_2, and 225_3 each choose and output one of the two inputs thereto according to the signals SEL_1, SEL_2, and SEL_3. Specifically, the selectors 225_1, 225_2, and 225_3 each output the signal fed to the first input terminal thereof, i.e., the vertical scanning start signal φVS, when the corresponding one of the signals SEL_1, SEL_2, and SEL_3 is high, and output the signal fed to the second input terminal thereof, i.e., the high-level direct-current voltage VDD, when the corresponding one of the signals SEL_1, SEL_2, and SEL_3 is low.

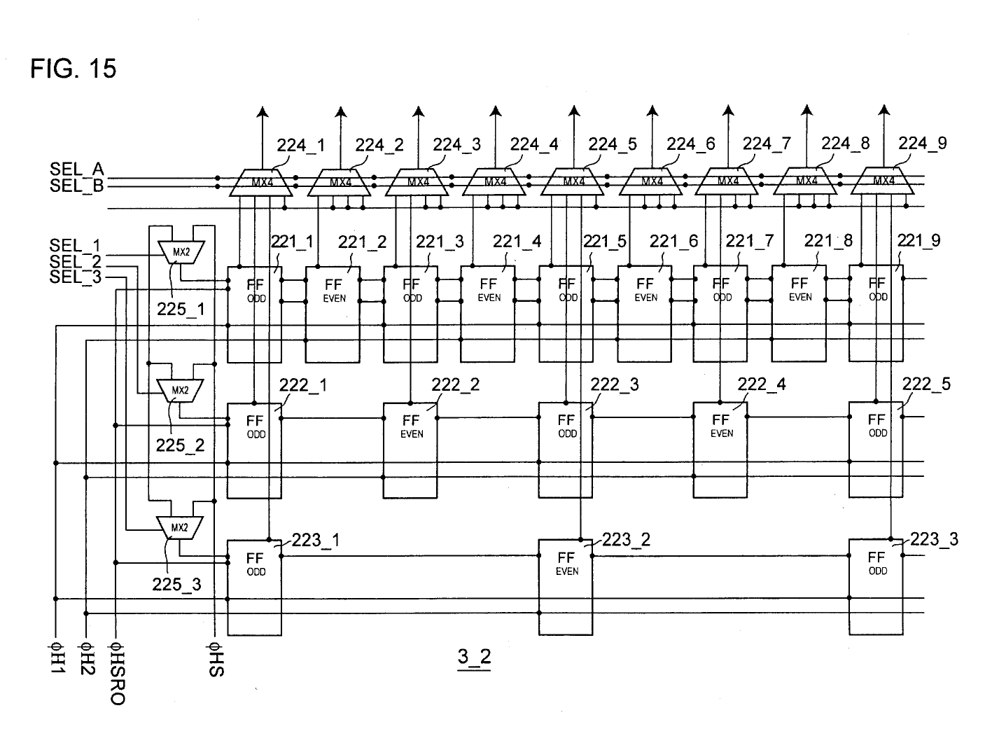

FIG. 15 shows the circuit configuration of the horizontal scanning circuit 3_2. As shown in FIG. 15, the horizontal scanning circuit 3_2 has largely the same configuration as the vertical scanning circuit 2_2. One difference is that the vertical scanning start signal φVS and the first and second vertical scanning signals φV1 and φV2 used in the latter are here replaced with the horizontal scanning start signal φHS and the first and second horizontal scanning signals φH1 and φH2. The horizontal scanning lines C_q of the sensing portion 1 are driven with the outputs of the selectors 224_q constituting the horizontal scanning circuit 3_2.

Another difference is that, as shown in FIG. 16, the flip-flops 221_1, 221_2, . . . , 222_1, 222_2, . . . 223_1, 223_2, . . . used in the horizontal scanning circuit 3_2 lack the analog switch 2215 as compared with the flip-flops 221_1, 221_2, . . . , 222_1, 222_2, . . . , 223_1, 223_2, . . . used in the vertical scanning circuit 2_2. This is because the horizontal scanning signals have higher frequencies than the vertical scanning signals, and therefore the omission of the analog switch 2215 does not affect the operation required here.

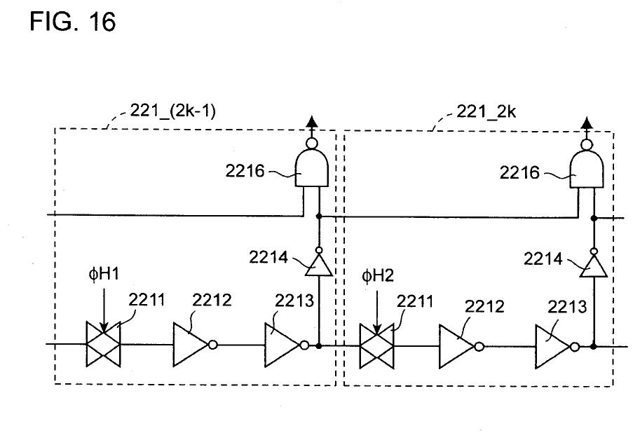

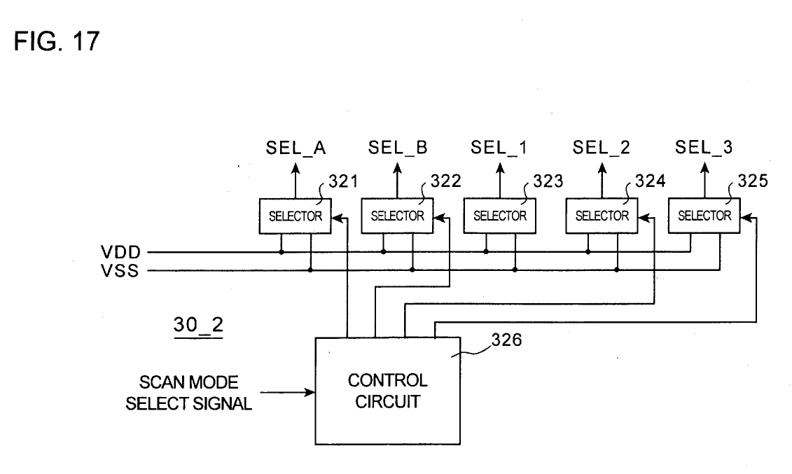

FIG. 17 shows the circuit configuration of the scan mode switcher 30_2. The scan mode switcher 30_2 includes selectors 321, 322, 323, 324, and 325 and a control circuit 326. The selectors 321, 322, 323, 324, and 325 each choose and output one of the high-level direct-current voltage VDD and a low-level direct-current voltage VSS according to the signals from the control circuit 326.

From the scan mode switcher 30_2, the signal output from the selector 321 is output as a signal SEL_A, the signal output from the selector 322 is output as a signal SEL_B, the signal output from the selector 323 is output as a signal SEL_1, the signal output from the selector 324 is output as a signal SEL_2, and the signal output from the selector 325 is output as a signal SEL_3.

When a first scan mode is requested by a scan mode select signal, the control circuit 326 controls the selectors 321, 322, 323, 324, and 325 in such a way that the selectors 321 and 322 choose the low-level direct-current voltage VSS, that the selector 323 chooses the high-level direct-current voltage VDD, and that the selectors 324 and 325 choose the low-level direct-current voltage VSS.

When a second scan mode is requested by the scan mode select signal, the control circuit 326 controls the selectors 321, 322, 323, 324, and 325 in such a way that the selector 321 chooses the high-level direct-current voltage VDD, that the selector 322 chooses the low-level direct-current voltage VSS, that the selector 323 chooses the low-level direct-current voltage VSS, that the selector 324 chooses the high-level direct-current voltage VDD, and that the selector 325 chooses the low-level direct-current voltage VSS.

When a third scan mode is requested by the scan mode select signal, the control circuit 326 controls the selectors 321, 322, 323, 324, and 325 in such a way that the selector 321 chooses the low-level direct-current voltage VSS, that the selector 322 chooses the high-level direct-current voltage VDD, that the selectors 323 and 324 choose the low-level direct-current voltage VSS, and that the selector 325 chooses the high-level direct-current voltage VDD.

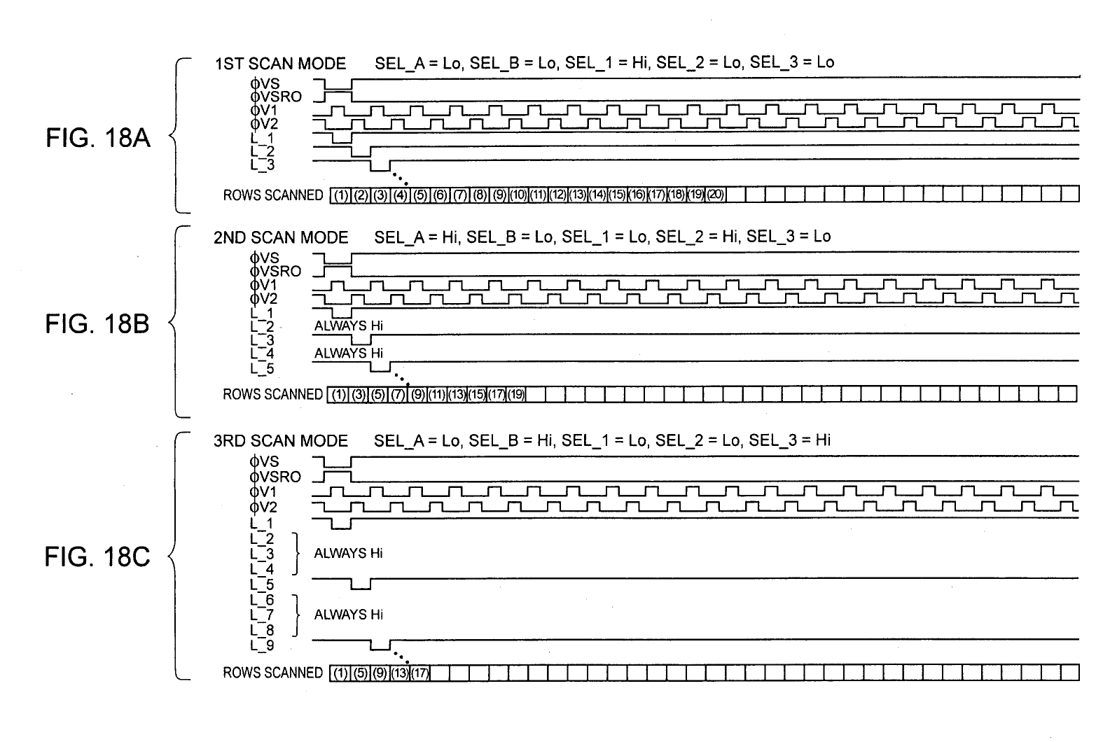

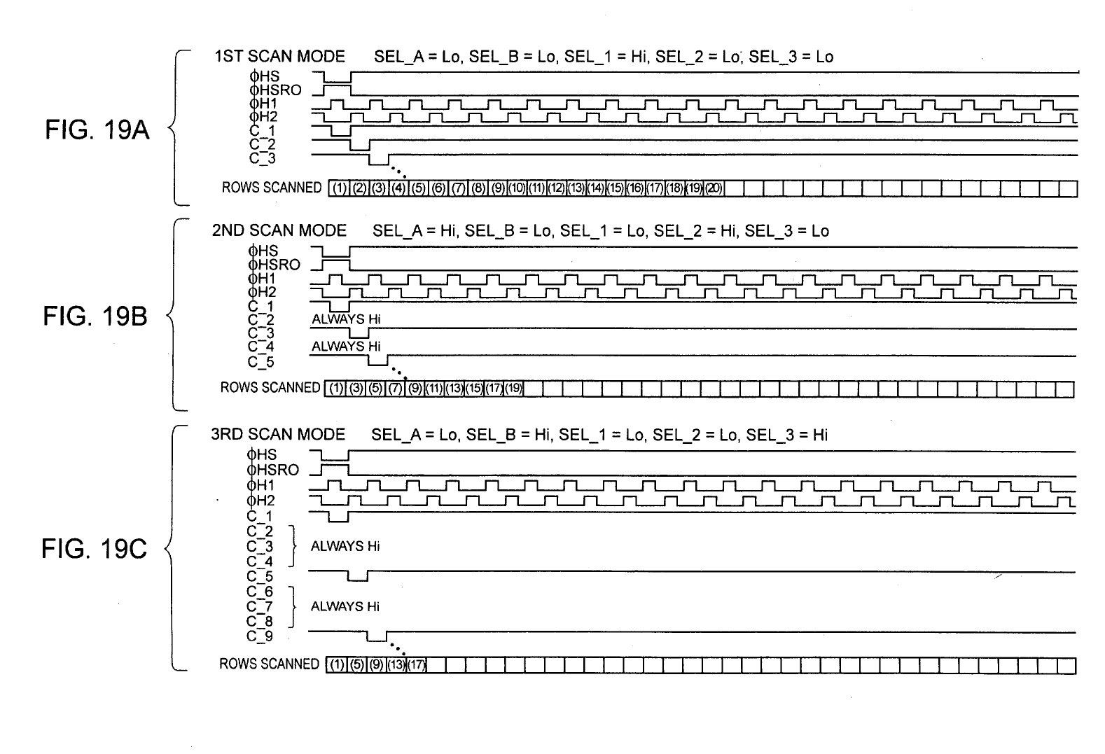

With the individual circuit blocks configured as described above, in the first scan mode, the drive signals for the vertical scanning lines L_1, L_2, . . . of the sensing portion 1 behave with respect to the vertical scanning start signal φVS and the first and second vertical scanning signals φV1 and φV2 as shown in a timing chart in FIG. 18A. Thus, the pixels of all the rows of the sensing portion 1 are scanned progressively, starting with the first row. On the other hand, the horizontal scanning start signal φHS and the first and second horizontal scanning signals φH1 and φH2 behave as shown in a timing chart in FIG. 19A. Thus, the pixels of all the columns of the sensing portion 1 are scanned progressively, starting with the first column. As a result, in the first scan mode, the data of all the pixels of the sensing portion 1 are read out.

In the second scan mode, the drive signals for the vertical scanning lines L_1, L_2, . . . of the sensing portion 1 behave with respect to the vertical scanning start signal φVS and the first and second vertical scanning signals φV1 and φV2 as shown in a timing chart in FIG. 18B. Thus, the pixels of the sensing portion 1 are scanned in the following order: the pixels in the first row, then those in the third row, then those in the fifth row, and so forth. On the other hand, the horizontal scanning start signal φHS and the first and second horizontal scanning signals φH1 and φH2 behave as shown in a timing chart in FIG. 19B. Thus, the pixels of the sensing portion 1 are scanned in the following order: the pixels in the first column, then those in the third column, then those in the fifth column, and so forth. As a result, in the second scan mode, the data of the pixels that are located simultaneously in the odd-numbered rows and in the odd-numbered columns of the sensing portion 1 are read out.

In the third scan mode, the drive signals for the vertical scanning lines L_1, L_2, . . . of the sensing portion 1 behave with respect to the vertical scanning start signal φVS and the first and second vertical scanning signals φV1 and φV2 as shown in a timing chart in FIG. 18C. Thus, the pixels of the sensing portion 1 are scanned in the following order: the pixels in the first row, then those in the fifth row, then those in the ninth row, and so forth. On the other hand, the horizontal scanning start signal φHS and the first and second horizontal scanning signals φH1 and φH2 behave as shown in a timing chart in FIG. 19C. Thus, the pixels of the sensing portion 1 are scanned in the following order: the pixels in the first column, then those in the fifth column, then those in the ninth column, and so forth. As a result, in the third scan mode, the data of the pixels that are located simultaneously in the (4X−3)th rows and in the (4Y−3)th columns of the sensing portion 1 are read out. Here, X and Y each represent a positive integral number.

In this way, in the second embodiment, interlaced scanning is possible. Here, interlaced scanning is achieved by providing a plurality of shift registers having different numbers of stages and performing scanning by the use of one selected from among those shift registers. Thus, interlaced scanning can be performed at the same scanning rate as when all photoelectric conversion elements are scanned without increasing the frequency of scanning pulses than when all photoelectric conversion elements are scanned. In addition, in the second embodiment, twice the frame rate achieved in the first embodiment is achieved with scanning pulses having the same frequency. In other words, in the second embodiment, the same frame rate as in the first embodiment is achieved with scanning pulses having half the frequency of those used in the first embodiment.

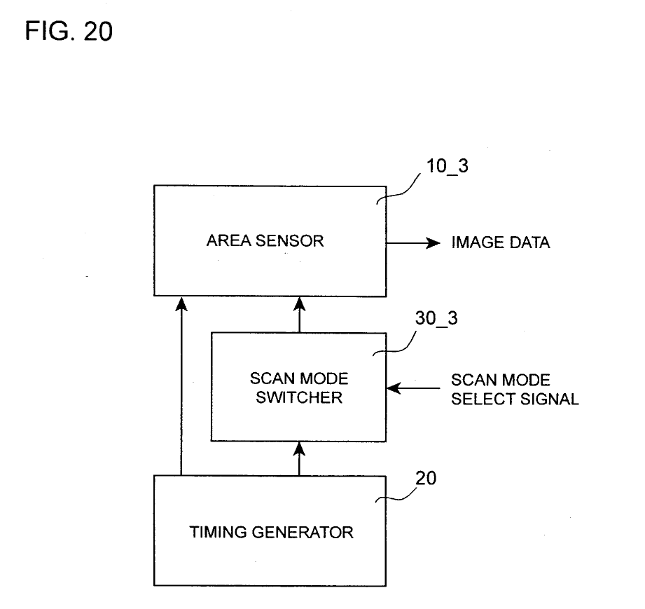

FIG. 20 is a block diagram of still another image-sensing apparatus incorporating a scanning circuit according to the invention. In FIG. 20, reference numeral 10_3 represents an X-Y address area sensor, reference numeral 20 represents a timing generator, and reference numeral 30_3 represents a scan mode switcher. The timing generator 20 here is the same as in the first embodiment, and therefore its descriptions will not be repeated.

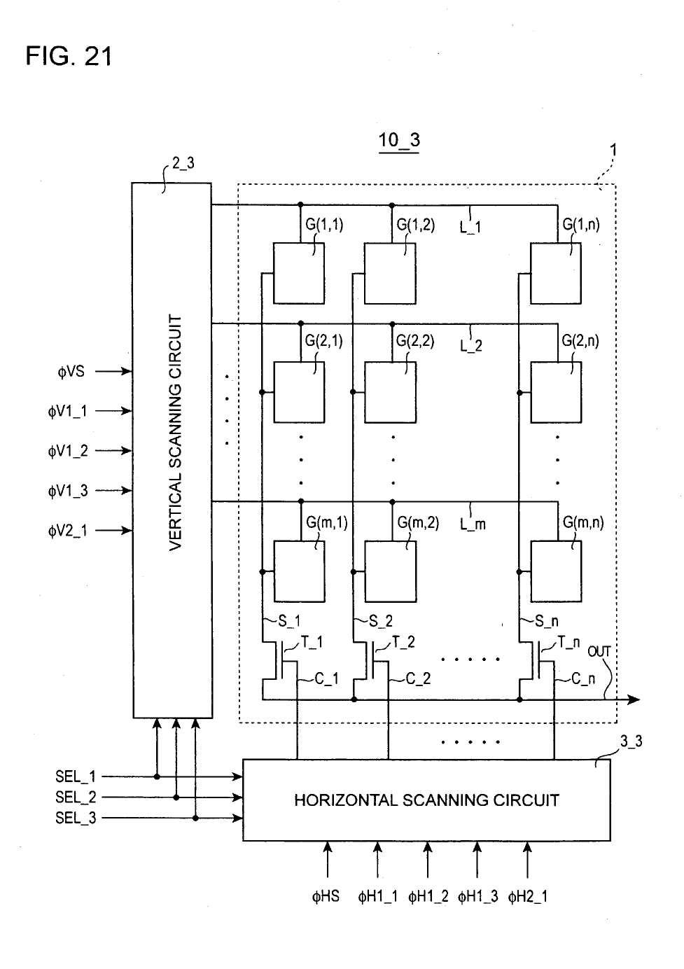

FIG. 21 is a block diagram of the X-Y address area sensor 10_3. As shown in FIG. 21, the X-Y address area sensor 10_3 includes a sensing portion 1, a vertical scanning circuit 2_2 for vertically scanning the sensing portion 1, and a horizontal scanning circuit 3_2 for horizontally scanning the sensing portion 1. The sensing portion 1 here is the same as in the first embodiment, and therefore its descriptions will not be repeated.

The vertical scanning circuit 2_3 receives a vertical scanning start signal φVS from the timing generator 20, and receives four vertical scanning signals φV1_{—}1, φV1_{—}2, φV_{—}3, and φV2_{—}1 and signals SEL_1, SEL_2, and SEL_3 from the scan mode switcher 30_3.

The horizontal scanning circuit 3_3 receives a horizontal scanning start signal φHS from the timing generator 20, and receives four horizontal scanning signals φH1_{—}1, φH1_{—}2, φH1_{—}3, and φH2_{—}1 and signals SEL_1, SEL_2, and SEL_3 from the scan mode switcher 30_3.

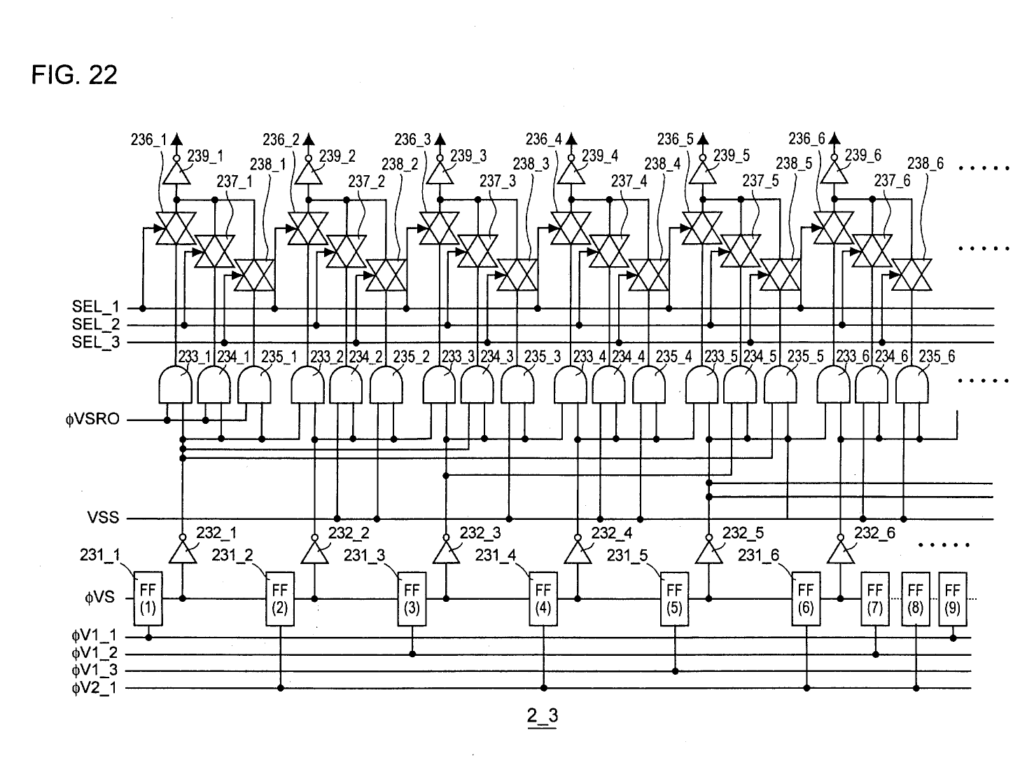

FIG. 22 shows the circuit configuration of the vertical scanning circuit 2_3. In FIG. 22, reference numerals 231_1, 231_2, . . . represent flip-flops, reference numerals 232_1, 232_2, . . . represent inverters, reference numerals 233_1, 233_2, . . . , 234_1, 234_2, . . . , 235_1, 235_2, . . . represent AND gates, reference numerals 236_1, 236_2, . . . , 237_1, 237_2, . . . 238_1, 238_2 . . . represent analog switches, and reference numerals 239_1, 239_2, . . . represent inverters.

The flip-flops 231_1, 231_2, . . . are all G latch type flip-flops. The flip-flops 231_1, 231_2, . . . are connected in series to form a shift register.

The flip-flop 231_1 receives the vertical scanning start signal φVS. The flip-flops 231_{—}p other than the flip-flop 231_1 each receive the output of the flip-flop 231_(p−1). The output of the flip-flop 231_{—}p is fed to the inverter 232_{—}p.

The AND gates 233_1, 234_1, and 235_1 each receive at one input terminal thereof the inverted signal φVSR0 of the vertical scanning start signal φVS, and receive at the other input terminal thereof the output of the inviter 232_1. The AND gates 233_{—}p other than the AND gate 233_1 each receive at one input terminal thereof the output of the inverter 232_(p−1), and receive at the other input terminal thereof the output of the inverter 232_{—}p.

Let k be a positive integral number. Then, the AND gates 234_(4k−3) other than the AND gate 234_1 each receive at one input terminal thereof the output of the inverter 232_(4k−5), and receive at the other input terminal thereof the output of the inverter 232_(4k−3). The AND gates 235_(4k−3) other than the AND gate 235_1 each receive at one input terminal thereof the output of the inverter 232_(4k−7), and receive at the other input terminal thereof the output of the inverter 232_(4k−3).

The AND gates 234_2k and 235_2k each receive at one input terminal thereof a low-level direct-current voltage VSS, and receive at the other input terminal thereof the output of the inverter 232_2k.

The AND gate 234_(4k−1) receives at one input terminal thereof the output of the inverter 232_(4k−3), and receives at the other input terminal thereof the output of the inverter 232_(4k−1). The AND gate 235_(4k−1) receives at one input terminal thereof the low-level direct-current voltage VSS, and receives at the other input terminal thereof the output of the inverter 232_(4k−1).

The outputs of the AND gates 233_{—}p, 234_{—}p, and 235_{—}p are fed, respectively through the analog switches 236_{—}p, 237_{—}p, and 238_{—}p, commonly to the inverter 239_{—}p. With the output of the inverter 239_{—}p, the vertical scanning line L_{—}p of the sensing portion 1 is driven.

The analog switches 236_{—}p, 237_{—}p, and 238_{—}p are turned ON and OFF by the signals SEL_1, SEL_2, and SEL_3, respectively. Specifically, when the signals SEL_1, SEL_2, and SEL_3 are high, the analog switches 236_{—}p, 237_{—}p, and 238_{—}p, respectively, are ON, and, when the signals SEL_1, SEL_2, and SEL_3 are low, the analog switches 236_{—}p, 237_{—}p, and 238_{—}p, respectively, are OFF.

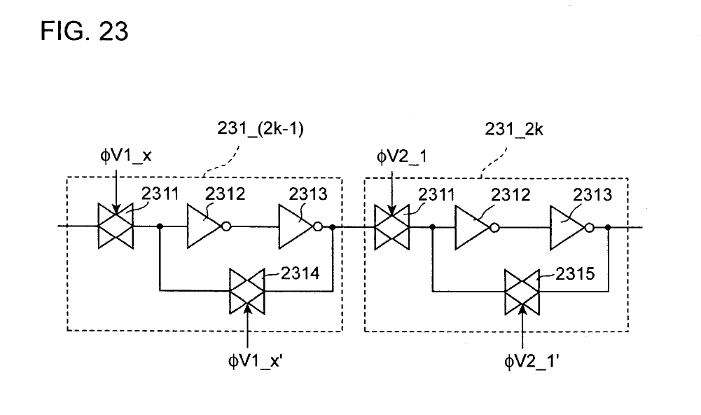

As shown in FIG. 23, the flip-flops 231_{—}p each include an analog switch 2311, inverters 2312 and 2313, and an analog switch 2314. A signal fed into the flip-flop 231_{—}p is fed through the analog switch 2311 to the inverter 2312. The output of the inverter 2312 is fed to the inverter 2313. The output of the inverter 2313 is fed through the analog switch 2314 to the inverter 2312. The output of the inverter 2313 is used as the output of the flip-flop 231_{—}p.

In the flip-flop 231_(8k−1), the analog switch 2311 is turned ON and OFF by the vertical scanning signal φV1_{—}1 and the analog switch 2314 is turned ON and OFF by the inverted signal φV1_{—}1′ of the vertical scanning signal φV1_{—}1 in such a way that, the analog switches 2311 and 2314 are, when the vertical scanning signal φV1_{—}1 is high, ON and OFF, respectively, and, when the vertical scanning signal φV1_{—}1 is low, OFF and ON, respectively.

In the flip-flop 231_(4k−1), the analog switch 2311 is turned ON and OFF by the vertical scanning signal φV1_{—}2 and the analog switch 2314 is turned ON and OFF by the inverted signal φV1_{—}2′ of the vertical scanning signal φV1_{—}2 in such a way that the analog switches 2311 and 2314 are, when the vertical scanning signal φV1_{—}2 is high, ON and OFF, respectively, and, when the vertical scanning signal φV1_2 is low, OFF and ON, respectively.

In the flip-flop 231_(8k−3), the analog switch 2311 is turned ON and OFF by the vertical scanning signal φV1_{—}3 and the analog switch 2314 is turned ON and OFF by the inverted signal φV1_{—}3′ of the vertical scanning signal φV1_{—}3 in such a way that the analog switches 2311 and 2314 are, when the vertical scanning signal φV1_{—}3 is high, ON and OFF, respectively, and, when the vertical scanning signal φV1_{—}3 is low, OFF and ON, respectively.

In the flip-flop 231_2k, the analog switch 2311 is turned ON and OFF by the vertical scanning signal φV2_{—}1 and the analog switch 2314 is turned ON and OFF by the inverted signal φV2_{—}1′ of the vertical scanning signal φV2_{—}1 in such a way that the analog switches 2311 and 2314 are, when the vertical scanning signal φV2_{—}1 is high, ON and OFF, respectively, and, when the vertical scanning signal φV2_{—}1 is low, OFF and ON, respectively.

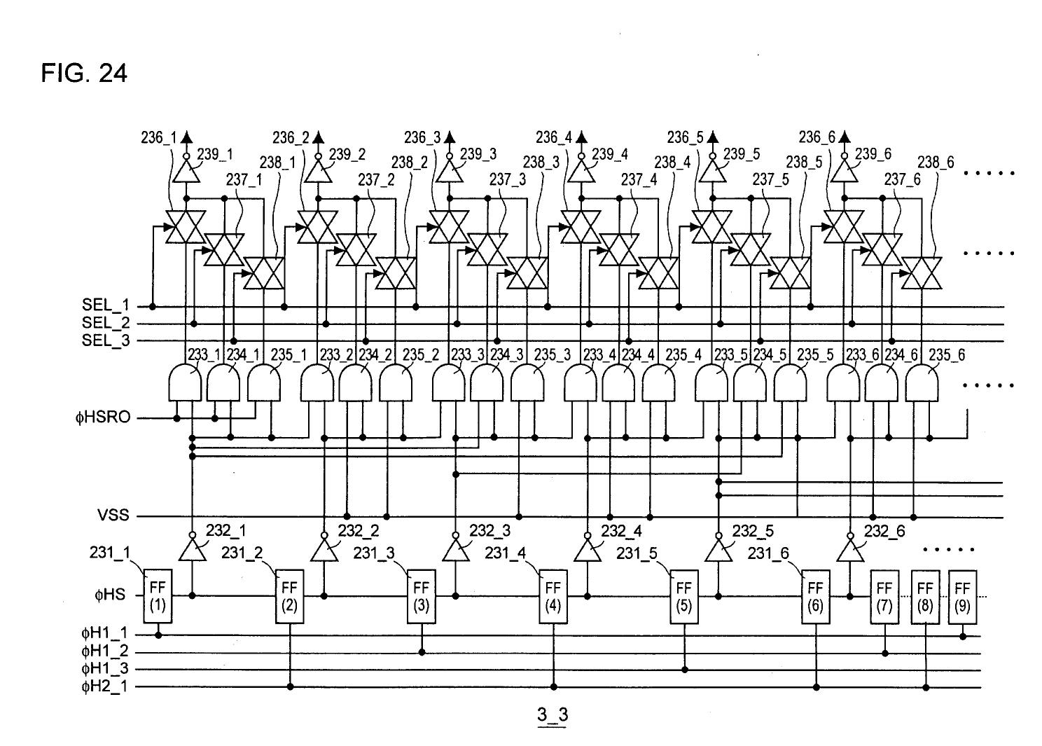

FIG. 24 shows the circuit configuration of the horizontal scanning circuit 3_3. As shown in FIG. 24, the horizontal scanning circuit 3_3 has largely the same configuration as the vertical scanning circuit 2_3. One difference is that the vertical scanning start signal φVS and the vertical scanning signals φV1_{—}1, φV1_{—}2, φV1_{—}3, and φV21 used in the latter are here replaced with the horizontal scanning start signal φHS and the horizontal scanning signals φH1_{—}1, φH1_{—}2, φH1_{—}3, and φH2_{—}1, respectively. The horizontal scanning lines C_q of the sensing portion 1 are driven with the outputs of the inverters 239_{—}q constituting the horizontal scanning circuit 3_3.

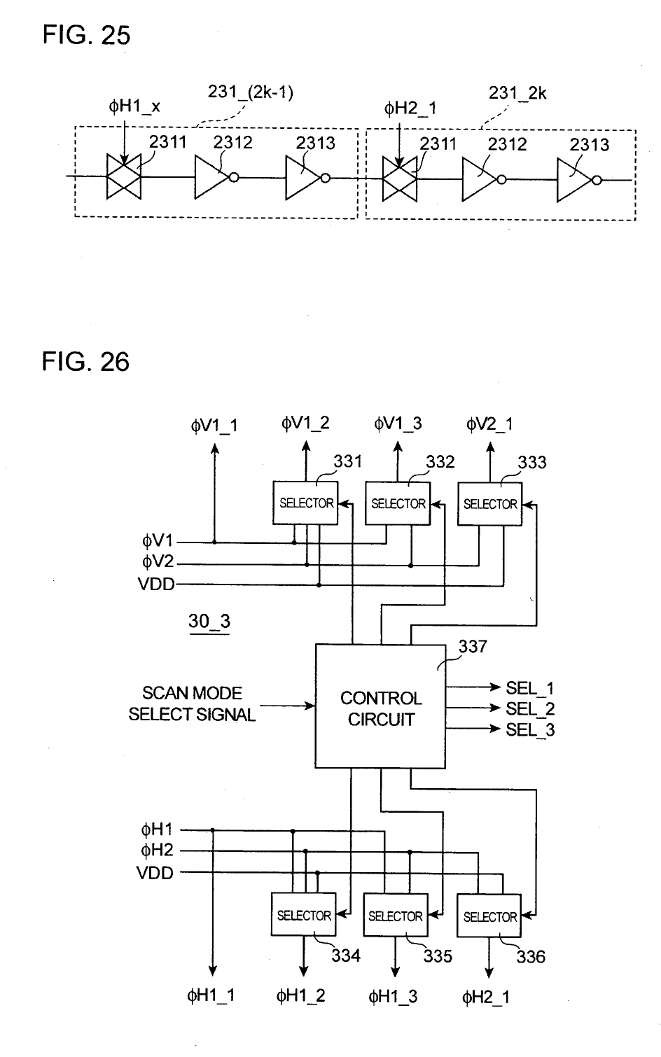

Another difference is that, as shown in FIG. 25, the flip-flops 231_1, 231_2, . . . , and 231_{—}m used in the horizontal scanning circuit 3_3 lack the analog switch 2314 as compared with the flip-flops 231_1, 231_2, and 231_{—}m used in the vertical scanning circuit 2_3. This is because the horizontal scanning signals have higher frequencies than the vertical scanning signals, and therefore the omission of the analog switch 2314 does not affect the operation required here.

FIG. 26 shows the circuit configuration of the scan mode switcher 30_3. The scan mode switcher 30_3 includes selectors 331, 332, 333, 334, 335, and 336 and a control circuit 337. The scan mode switcher 30_3 receives a first vertical scanning signal φV1, a second vertical scanning signal φV2, a first horizontal scanning signal φH1, a second horizontal scanning signal φH2, and a high-level direct-current voltage VDD, all output from the timing generator 20.

The selector 331 chooses and outputs one of the first vertical scanning signal φV1, the second vertical scanning signal φV2, and the high-level direct-current voltage VDD, whichever the control circuit 337 instructs it to select. The selector 332 chooses and outputs one of the first vertical scanning signal φV1and the second vertical scanning signal φV2, whichever the control circuit 337 instructs it to select. The selector 333 chooses and outputs one of the second vertical scanning signal φV2and the high-level direct-current voltage VDD, whichever the control circuit 337 instructs it to select.

The selector 334 chooses and outputs one of the first horizontal scanning signal φH1, the second horizontal scanning signal φH2, and the high-level direct-current voltage VDD, whichever the control circuit 337 instructs it to select. The selector 335 chooses and outputs one of the first horizontal scanning signal φH1 and the second horizontal scanning signal φH2, whichever the control circuit 337 instructs it to select. The selector 336 chooses and outputs one of the second horizontal scanning signal φH2 and the high-level direct-current voltage VDD, whichever the control circuit 337 instructs it to select.

From the scan mode switcher 30_3, the first vertical scanning signal φV1 is output as a signal φV1_{—}1, the signal output from the selector 331 is output as a signal φV1_{—}2, the signal output from the selector 332 is output as a signal φV1_{—}3, and the signal output from the selector 333 is output as a signal φV2_{—}1.

From the scan mode switcher 30_3, the first horizontal scanning signal φH1 is output as a signal φH1_{—}1, the signal output from the selector 334 is output as a signal φH1_{—}2, the signal output from the selector 335 is output as a signal φH1_{—}3, and the signal output from the selector 336 is output as a signal φH2_{—}1.

When a first scan mode is requested by a scan mode select signal, the control circuit 337 controls the selectors 331, 332, 333, 334, 335, and 336 in such a way that the selectors 331 and 332 choose the first vertical scanning signal φV1, that the selector 333 chooses the second vertical scanning signal φV2, that the selectors 334 and 335 choose the first horizontal scanning signal φH1, and that the selector 336 chooses the second horizontal scanning signal φH2. The control circuit 337 also generates and outputs signals SEL_1, SEL_2, and SEL_3. When the first scan mode is requested by the scan mode select signal, the control circuit 337 turns the signal SEL_1 high and the signals SEL_2 and SEL_3 low.

When a second scan mode is requested by the scan mode select signal, the control circuit 337 controls the selectors 331, 332, 333, 334, 335, and 336 in such a way that the selector 331 chooses the second vertical scanning signal φV2, that the selector 332 chooses the first vertical scanning signal φV1, that the selector 333 chooses the high-level direct-current voltage VDD, that the selector 334 chooses the second horizontal scanning signal φH2, that the selector 335 chooses the first horizontal scanning signal φH1, and that the selector 336 chooses the high-level direct-current voltage VDD. Moreover, when the second scan mode is requested by the scan mode select signal, the control circuit 337 turns the signal SEL_1 low, the signal SEL_2 high, and the signal SEL_3 low.

When a third scan mode is requested by the scan mode select signal, the control circuit 337 controls the selectors 331, 332, 333, 334, 335, and 336 in such a way that the selector 331 chooses the high-level direct-current voltage VDD, that the selector 332 chooses the second vertical scanning signal φV2, that the selector 333 chooses the high-level direct-current voltage VDD, that the selector 334 chooses the high-level direct-current voltage VDD, that the selector 335 chooses the second horizontal scanning signal φH2, and that the selector 336 chooses the high-level direct-current voltage VDD. Moreover, when the third scan mode is requested by the scan mode select signal, the control circuit 337 turns the signals SEL_1 and SEL_2 low and the signal SEL_3 high.

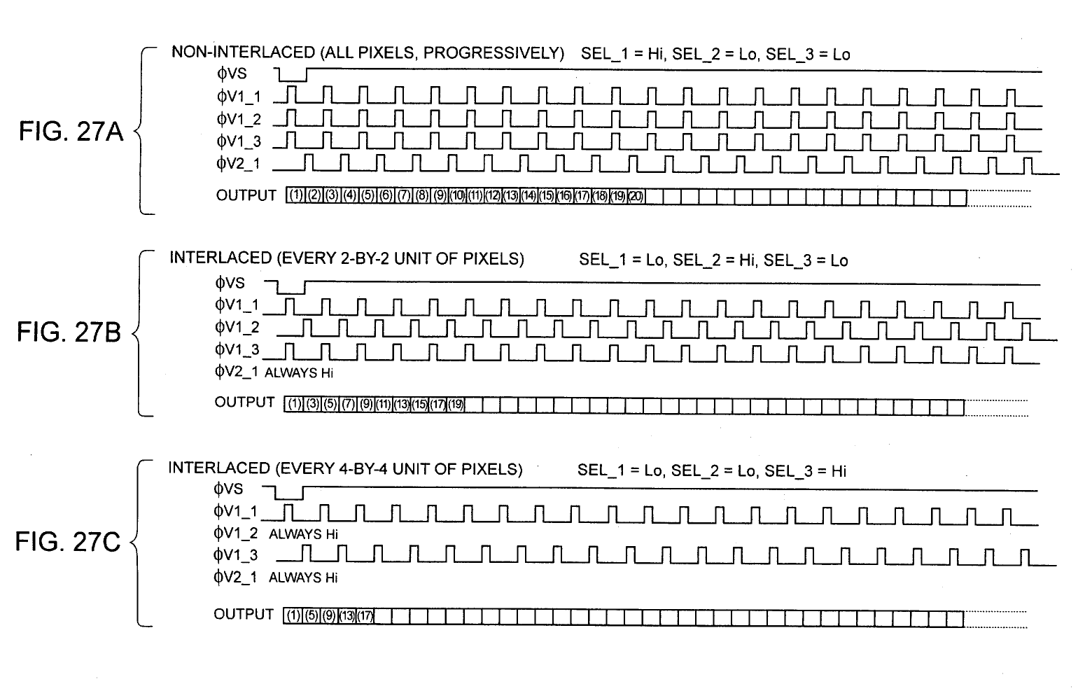

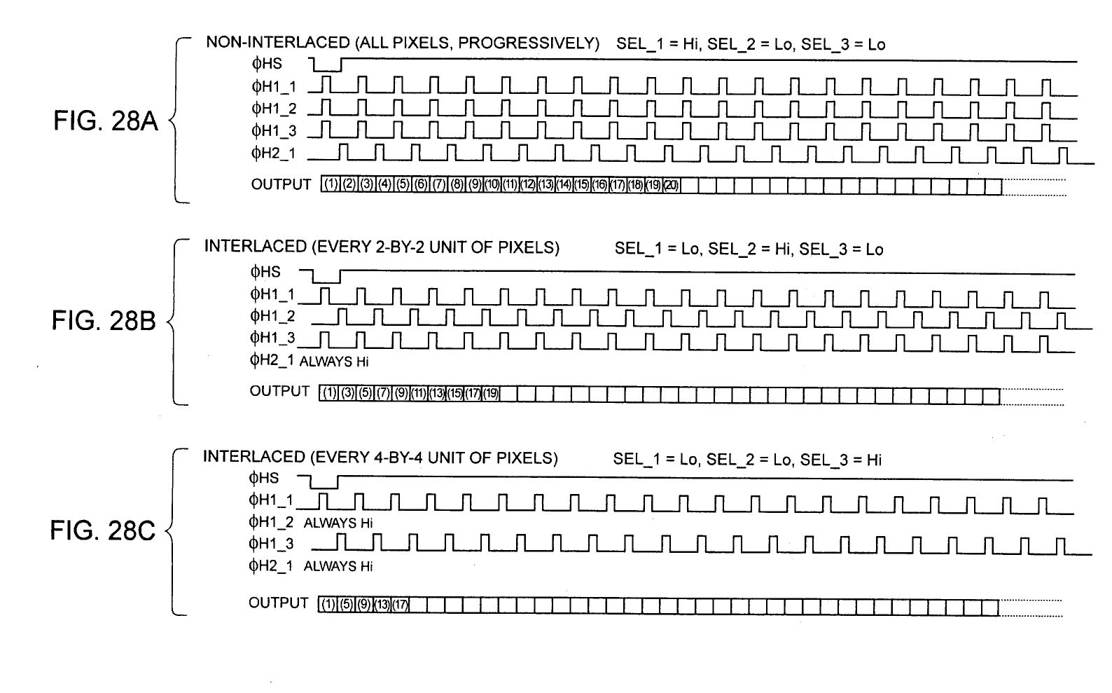

With the individual circuit blocks configured as described above, in the first scan mode, the vertical scanning start signal φVS and the vertical scanning signals φV1_{—}1, φV1_{—}2, φV1_{—}3, and φV2_{—}1 behave as shown in a timing chart in FIG. 27A. In addition, the signals SEL_1, SEL_2, and SEL_3 are high, low, and low, respectively. Thus, the pixels of all the rows of the sensing portion 1 are scanned progressively, starting with the first row. On the other hand, the horizontal scanning start signal φHS and the horizontal scanning signals φH1_{—}1, φH1_{—}2, φH1_{—}3, and φH2_1 behave as shown in a timing chart in FIG. 28A. In addition, the signal SEL_1, SEL_2, and SEL_3 are high, low, and low, respectively. Thus, the pixels of all the columns of the sensing portion 1 are scanned progressively, starting with the first column. As a result, in the first scan mode, the data of all the pixels of the sensing portion 1 are read out.

In the second scan mode, the vertical scanning start signal φVS and the vertical scanning signals φV_{—}1, φV1_{—}2, φV1_{—}3, and φV2_{—}1 behave as shown in a timing chart in FIG. 27B. In addition, the signals SEL_1, SEL_2, and SEL_3 are low, high, and low, respectively. Thus, the pixels of the sensing portion 1 are scanned in the following order: the pixels in the first row, then those in the third row, then those in the fifth row, and so forth. On the other hand, the horizontal scanning start signal φHS and the horizontal scanning signals φH1_{—}1, φH1_{—}2, φH1_{—}3, and φH2_{—}1 behave as shown in a timing chart in FIG. 28B. In addition, the signals SEL_1, SEL_2, and SEL_3 are low, high, and low, respectively. Thus, the pixels of the sensing portion 1 are scanned in the following order: the pixels in the first column, then those in the third column, then those in the fifth column, and so forth. As a result, in the second scan mode, the data of the pixels that are located simultaneously in the odd-numbered rows and in the odd-numbered columns of the sensing portion 1 are read out.

In the third scan mode, the vertical scanning start signal φVS and the vertical scanning signals φV1 _{—}1, φV1_{—}2, φV1_{—}3, and φV2_{—}1 behave as shown in a timing chart in FIG. 27C. In addition, the signals SEL_1, SEL_2, and SEL_3 are low, low, and high, respectively. Thus, the pixels of the sensing portion 1 are scanned in the following order: the pixels in the first row, then those in the fifth row, then those in the ninth row, and so forth. On the other hand, the horizontal scanning start signal φHS and the horizontal scanning signals φH1_{—}1, φH1_{—}2, φH1_{—}3, and φH2_{—}1 behave as shown in a timing chart in FIG. 28C. In addition, the signals SEL_1, SEL_2, and SEL_3 are low, low, and high, respectively. Thus, the pixels of the sensing portion 1 are scanned in the following order: the pixels in the first column, then those in the fifth column, then those in the ninth column, and so forth. As a result, in the third scan mode, the data of the pixels that are located simultaneously in the (4X-3)th rows and in the (4Y-3)th columns of the sensing portion 1 are read out. Here, X and Y each represent a positive integral number.

In this way, in the third embodiment, interlaced scanning is possible. The scanning circuit is composed of G latch type flip-flops, and, for these flip-flops, a plurality of lines through which to feed them with strobe signals (signals that make them take in data) so that each flip-flop is fed with a strobe signal through one of those lines that corresponds to that flip-flop. Thus, by applying scanning pulses to the lines through which strobe signals are fed to the flip-flops corresponding to the pixels that need to be scanned, and by applying, instead of scanning pluses, a direct-current voltage, i.e., a always active signal, to the lines through which strobe signals are fed to the flip-flops corresponding to the pixels that do not need to be scanned, it is possible to perform interlaced scanning. In addition, interlaced scanning can be performed at the same scanning rate as when all photoelectric conversion elements are scanned without increasing the frequency of scanning pulses than when all photoelectric conversion elements are scanned. Furthermore, in the third embodiment, twice the frame rate achieved in the first embodiment is achieved with scanning pulses having the same frequency. In other words, in the third embodiment, the same frame rate as in the first embodiment is achieved with scanning pulses having half the frequency of those used in the first embodiment.

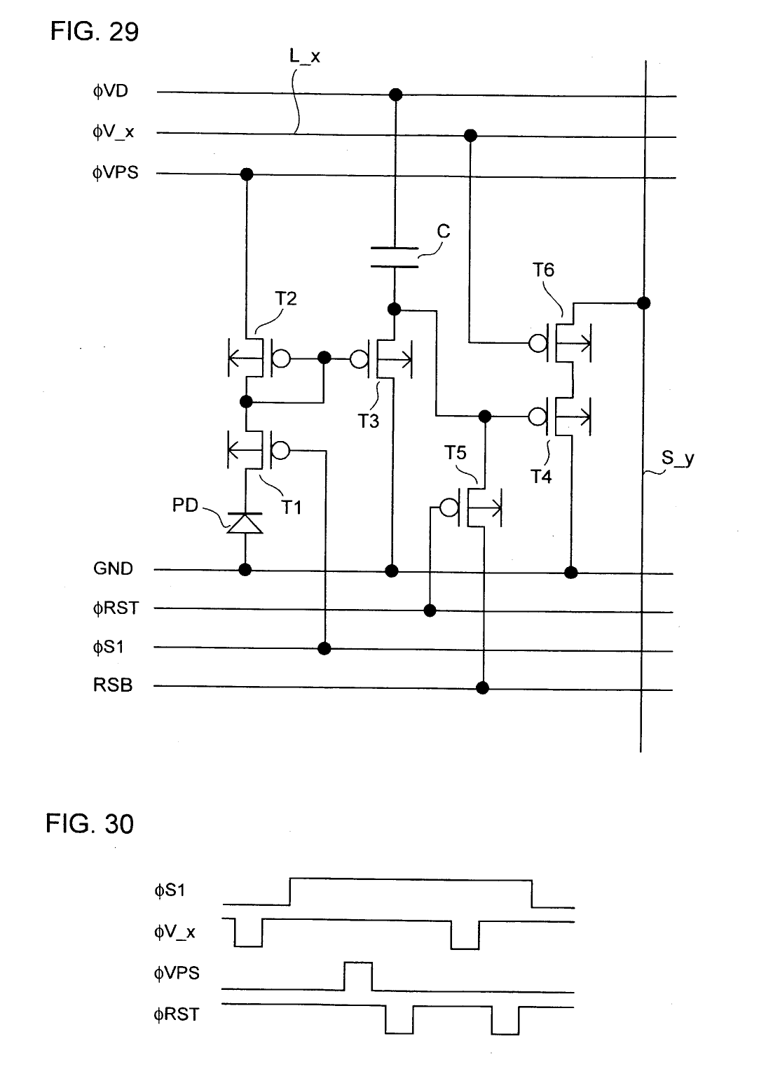

Now, how each pixel G(x, y) of the sensing portion 1 is configured in the embodiments described above will be described. FIG. 29 shows an example of the circuit configuration of the pixel G(x, y). Here, x and y each represent a positive integral number.

A photodiode PD has its anode connected to ground GND, and has its cathode connected to the drain of a p-channel MOS transistor T1. The source of the transistor Ti is connected to the gate and drain of a p-channel MOS transistor T2, and to the gate of a p-channel MOS transistor T3. The gate of the transistor T1 is driven by a signal φS1. The transistor T2 receives a signal φVPS at its source.

The source of the transistor T3 is connected to the gate of a p-channel MOS transistor T4, to the source of a p-channel MOS transistor T5, and to one end of a capacitor C that receives at the other end a direct-current voltage VDD. The drain of the transistor T3 is connected to ground GND.

The source of the transistor T4 is connected to the drain of a p-channel MOS transistor T6. The drain of the transistor T4 is connected to ground GND. The gate of the transistor T5 is driven by a signal φRST. The transistor T5 receives at its drain a direct-current voltage RSB lower than but roughly equal to the direct-current voltage VDD. The source of the transistor T6 is connected to a signal line _y. The gate of the transistor T6 is connected to a vertical scanning line L_x.

First, the operation of the pixel during image sensing will be described. It is to be noted that the following description deals with an example in which the image-sensing apparatus as a whole is set to operate in the mode in which the data of all the pixels are read out. During image sensing, the signal φS1 remains low, and thus the transistor T1 remains ON. The signal φRST remains high, and thus the transistor T5 remains OFF. The signal φVPS is a low direct-current voltage that makes the transistor T2 operate in a subthreshold region.

A current commensurate with the amount of incident light occurs in the photodiode PD, and, owing to the subthreshold characteristic of the MOS transistor, a voltage natural-logarithmically proportional to the photoelectric current appears at the gates of the transistors T2 and T3. A current commensurate with this voltage flows through the capacitor C to the drain of the transistor T3, and thus the capacitor C is charged. Accordingly, the gate voltage of the transistor T4 is natural-logarithmically proportional to the integral of the amount of light incident on the photodiode PD.

When the signal φV_x that drives the vertical scanning line L_x turns low, the transistor T6 turns ON and thereby causes the transistor T4 to operate as a source follower. As a result, a voltage natural-logarithmically proportional to the integral of the amount of light incident on the photodiode PD appears on the signal line S_y.

This example assumes that the pixels have integration capability and are of the logarithmic conversion type. However, the pixels may lack integration capability, and may be of any other type than the logarithmic conversion type.

Next, the operation of the pixel during detection of pixel-to-pixel variations in sensitivity will be described with reference to a timing chart shown in FIG. 30. It is to be noted that the following description deals with an example in which the image-sensing apparatus as a whole is set to operate in the mode in which the data of all the pixels are read out. After the signal φV_x that drives the vertical scanning line L_x turns low and thus the data of the pixel is read out, first, the signal φS1 is turned high to turn the transistor T1 OFF. This starts resetting.

Now, positive electric charge starts flowing into the transistor T2 through its source to recombine with the positive electric charge accumulated at the gate and drain of the transistor T2 and at the gate of the transistor T3. Thus, the potential at the gate and drain of the transistor T2 rises up to a certain level.

However, when the potential at the gate and drain of the transistor T2 has risen up to that certain level, resetting slows down. This tendency is particularly marked when a bright object has suddenly become dim. To overcome this, next, the signal φVPS fed to the source of the transistor T2 is raised to a higher voltage than during image sensing. Raising the source voltage of the transistor T2 in this way results in increasing the amount of positive electric charge that flows into the transistor T2 through its source, and thus prompts the recombination therewith of the negative electric charge accumulated at the gate of the transistor T3.

Accordingly, the potential at the gate and drain of the transistor T2 rises further. Then, the signal φVPS fed to the source of the transistor T2 is turned back to the low voltage it has during image sensing to bring the potential state of the transistor T2 back to its original state. After the potential state of the transistor T2 has been brought back to its original state in this way, first, a low-level pulse is fed as the signal φRST to transistor T5 to turn it ON so that the voltage at the node between the capacitor C and the gate of the transistor T4 is initialized.

When the voltage at the node between the capacitor C and the gate of the transistor T4 becomes commensurate with the gate voltage of the transistor T2 thus reset, the signal φV_x that drives the vertical scanning line L_x is turned low to turn the transistor T6 ON. This causes an output current that represents the pixel-to-pixel variation in sensitivity of this particular pixel to flow by way of the signal line S_y.

At this time, the transistor T4 operates as a source follower, and therefore the noise component appears as a voltage signal on the signal line S_y. Thereafter, a low-level pulse is fed again as the signal φRST to the transistor T5 to turn it ON so that the voltage at the node between the capacitor C and the gate of the transistor T4 is reset, and then the signal φS1 is turned low to turn the transistor T1 ON, making the pixel ready to perform image sensing.

In a case where pixel data are read out from every two-by-two unit of pixels, the signal φS1 is replaced with a signal φS4, which will be described later; in a case where pixel data are read out from every four-by-four unit of pixels, the signal φS1 is replaced with a signal φS16, which will be described later.

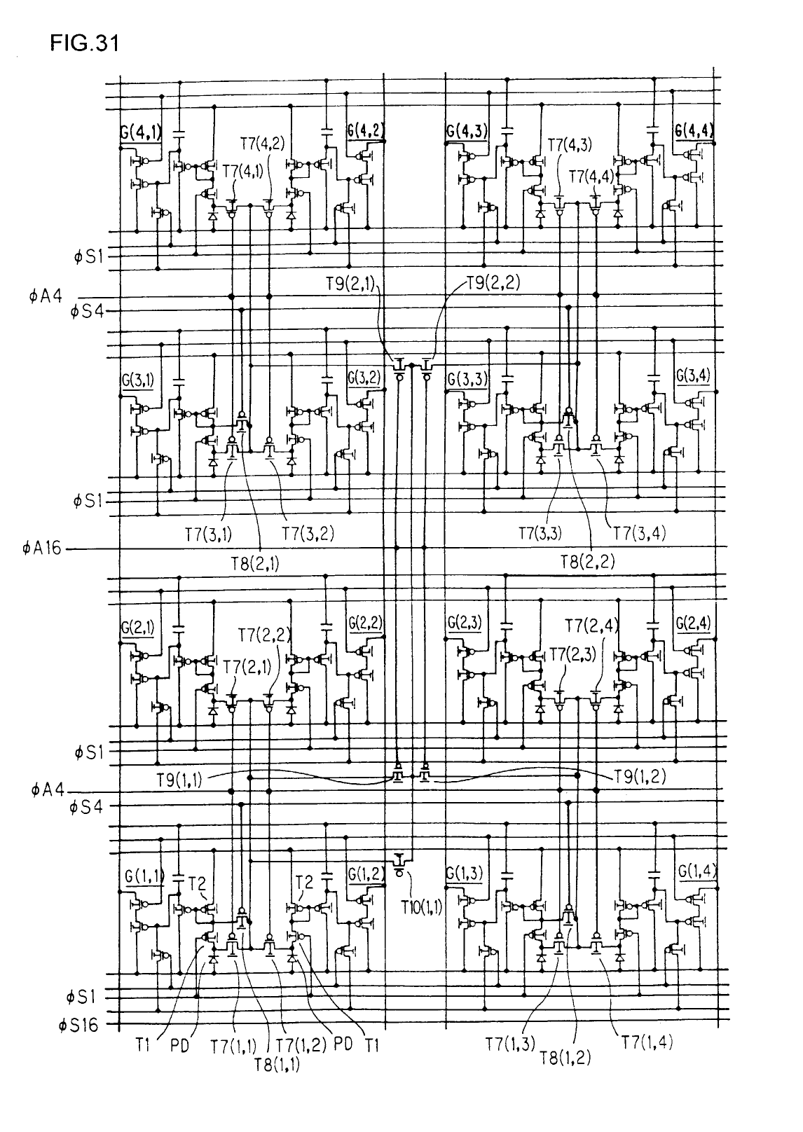

FIG. 31 shows a first circuit configuration for interconnection between pixels. FIG. 31 shows 16 pixels extracted from the sensing portion 1 which form a four-by-four unit. In each pixel G(x, y), the photodiode PD has its cathode connected to the drain of a p-channel MOS transistor T7(x, y).

The sources of the transistors T7(2x−1, 2y−1), T7(2x−1, 2y), T7(2x, 2y−1), and T7(2x, 2y) are connected commonly to the drain of a p-channel MOS transistor T8(x, y). The gate of the transistor T7(x, y) is driven by a signal φA4. The source of the transistor T8(x, y) is connected to the node between the transistors T1 and T2 of the pixel G(2x−1, 2y-1). The gate of the transistor T8(x, y) is driven by a signal φS4.

Moreover, the sources of the transistors T7(2x−1, 2y−1), T7(2x−1, 2y), T7(2x, 2y−1), and T7(2x, 2y) are connected commonly also to the drain of a p-channel MOS transistor T9(x, y). The sources of the transistors T9(2x−1, 2y−1), T9(2x−1, 2y), T9(2x, 2y−1), and T9(2x, 2y) are connected commonly to the drain of a p-channel MOS transistor T10(x, y). The gate of the transistor T9(x, y) is driven by a signal φA16. The source of the transistor T10(x, y) is connected to the node between the transistors T1 and T2 of the pixel G(4x−3, 4y−3). The gate of the transistor T10(x, y) is driven by a signal φS16.

In the first scan mode, i.e., when the data of all the pixels are read out, a signal φPDDA (a signal that turns high when the photodiode PD needs to be disabled) is used as the signal φS1, while the signals φS4, φS16, φA4, and φA16 are kept high. Accordingly, the transistors T7(x, y), T8(x, y), T9(x, y) and T10(x, y) are OFF all the time, and the transistor T1 turns ON at readout. Thus, the photoelectric current occurring in each pixel G(x, y) is read out pixel by pixel.

In the second scan mode, i.e., when the data of the pixels that are located simultaneously in the odd-numbered rows and in the odd-numbered columns are read out, the signal φPDDA is used as the signal φS4, while the signals φS1, φS16, and φA16 are kept high, and the signal φA4 is kept low. Accordingly, the transistors T1, T9(x, y), and T10(x, y) are OFF all the time, the transistor T7(x, y) is ON all the time, and the transistor T8(x, y) turns ON at readout. Thus, the photoelectric currents occurring in four pixels (forming a two-by-two unit), namely G(2x−1, 2x−1), G(2x−1, 2x), G(2x, 2x−1), and G( 2x, 2x), are added together in the pixel G(2x−1, 2x−1), and the sum is read out.

In the third scan mode, i.e., when the data of the pixels that are located simultaneously in the (4x-3)th rows and in the (4x-3)th columns are read out, the signal φPDDA is used as the signal φS16, while the signals φS1 and φS4 are kept high, and the signals φA4 and φA16 are kept low. Accordingly, the transistors T1 and T8(x, y) are OFF all the time, the transistors T7(x, y) and T9(x, y) are ON all the time, and the transistor T10(x, y) turns ON at readout. Thus, the photoelectric currents occurring in 16 pixels (forming a four-by-four unit), namely G(2w−1, 2w−1), G(2w−1, 2w), G(2w−1, 2w+1), G(2w−1, 2w+2), G(2w, 2w−1), G(2w, 2w), G(2w, 2w+1), G(2w, 2w+2), G(2w+1, 2w−1), G(2w+1, 2w), G(2w+1, 2w+1), G(2w+1, 2w+2), G(2w+2, 2w−1), G(2 w+2, 2w), G(2w+2, 2w+1), and G(2w+2, 2w+2), are added together in the pixel G(2w−1, 2w−1), and the sum is read out. Here, w represents an odd number.

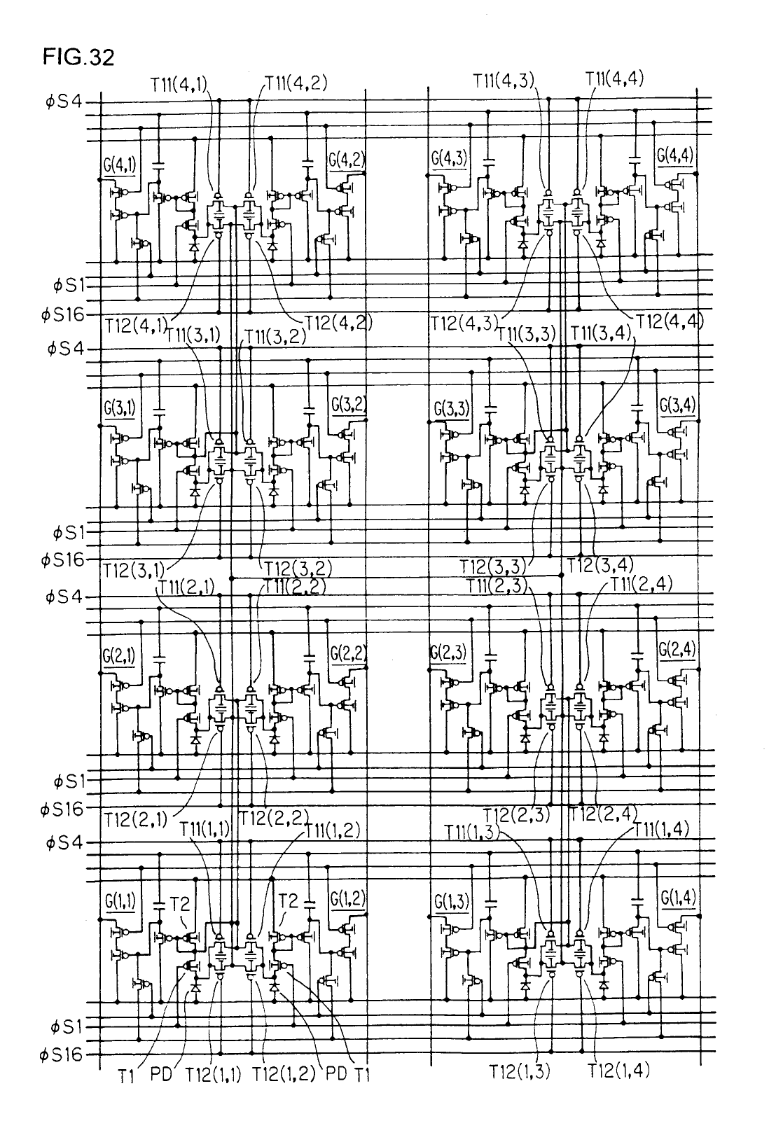

FIG. 32 shows a second circuit configuration for interconnection between pixels. FIG. 32 shows 16 pixels extracted from the sensing portion 1 which form a four-by-four unit. In each pixel G(x, y), the photodiode PD has its cathode connected to the drain of a p-channel MOS transistor T11(x, y) and to the drain of a p-channel MOS transistor T12(x, y).

The sources ofthe transistors T11(2x−1, 2y−1), T11(2x−1, 2y), T11(2x, 2y−1), and T11(2x, 2y) are connected commonly to the node between the transistors T1 and T2 of the pixel G(2x−1, 2y−1). The gate of the transistor T11(x, y) is driven by the signal φS4.

The sources of the transistors T12(2w−1, 2w−1), T12(2w−1, 2w), T12(2w−1, 2w+1), T12(2w−1, 2w+2), T12(2w, 2w−1), T12(2w, 2w), T12(2w, 2w+1), T12(2w, 2w+2), T12(2w+1, 2w−1), T12(2w+1, 2w), T12(2w+1, 2w+1), T12(2w+1, 2w+2), T12(2w+2, 2w−1), T12(2w+2, 2w), T12(2w+2, 2w+1), T12(2w+2, 2w+2) are connected commonly to the node between the transistors T1 and T2 of the pixel G(2w−1, 2w−1). The gate of the transistor T12(x, y) is driven by the signal φS16. Here, w represents an odd number.

In the first scan mode, i.e., when the data of all the pixels are read out, a signal φPDDA (a signal that turns high when the photodiode PD needs to be disabled) is used as the signal φS1, while the signals φS4 and φS16 are kept high. Accordingly, the transistors T11(x, y) and T12(x, y) are OFF all the time, and the transistor T1 turns ON at readout. Thus, the photoelectric current occurring in each pixel G(x, y) is read out pixel by pixel.

In the second scan mode, i.e., when the data of the pixels that are located simultaneously in the odd-numbered rows and in the odd-numbered columns are read out, the signal φPDDA is used as the signal φS4, while the signals φS1 and φS16 are kept high. Accordingly, the transistors T1 and T12(x, y) are OFF all the time, and the transistor T11(x, y) turns ON at readout. Thus, the photoelectric currents occurring in four pixels (forming a two-by-two unit), namely G(2x−1, 2x−1), G(2x−1, 2x), G(2x, 2x−1), and G(2x, 2x), are added together in the pixel G(2x−1, 2x−1), and the sum is read out.

In the third scan mode, i.e., when the data of the pixels that are located simultaneously in the (4x-3)th rows and in the (4x-3)th columns are read out, the signal φPDDA is used as the signal φS16, while the signals φS1 and φS4 are kept high. Accordingly, the transistors T1 and T11(x, y) are OFF all the time, and the transistor T12(x, y) turns ON at readout. Thus, the photoelectric currents occurring in 16 pixels (forming a four-by-four unit), namely G(2w−1, 2w−1), G(2w−1, 2w), G(2w−1, 2w+1), G(2w−1, 2w+2), G(2w, 2w−1), G(2w, 2w), G(2w, 2w+1), G(2w, 2w+2), G(2w+1, 2w−1), G(2w+1, 2w), G(2w+1, 2w+1), G(2w+1, 2w+2), G(2w+2, 2w−1), G(2w+2, 2w), G(2w+2, 2w+1), and G(2w+2, 2w+2), are added together in the pixel G(2w−1, 2w−1), and the sum is read out. Here, w represents an odd number.

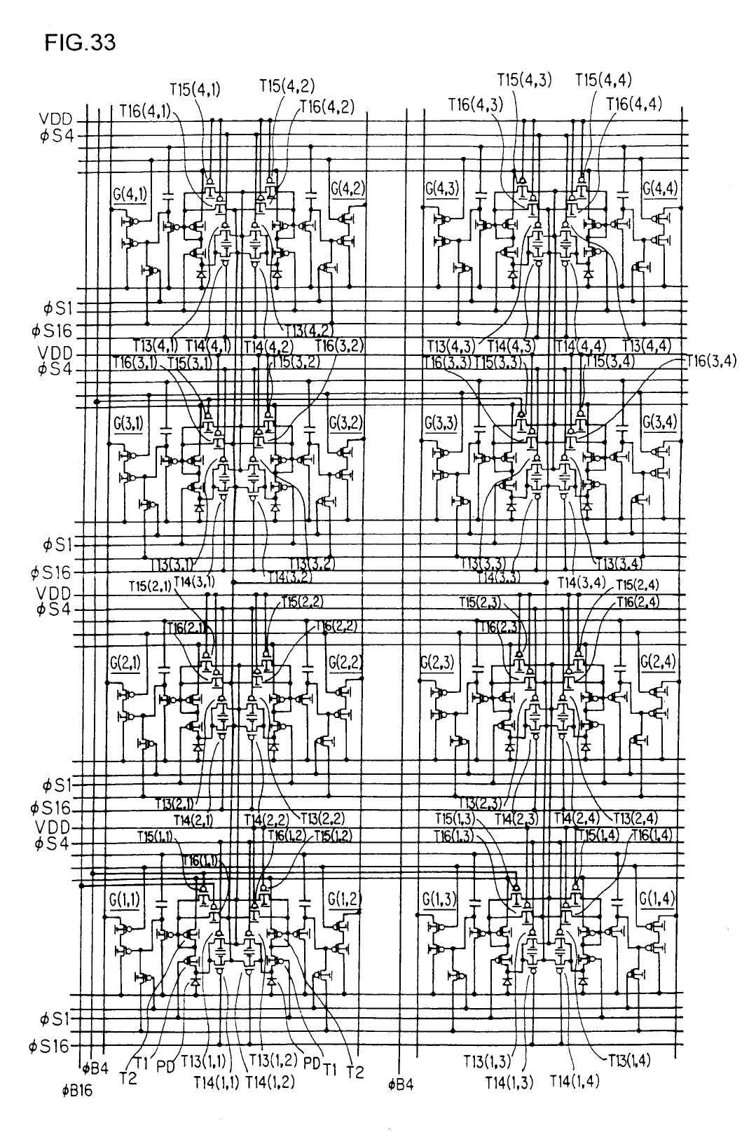

FIG. 33 shows a third circuit configuration for interconnection between pixels. FIG. 33 shows 16 pixels extracted from the sensing portion 1 which form a four-by-four unit. In each pixel G(x, y), the photodiode PD has its cathode connected to the drain of a p-channel MOS transistor T13(x, y) and to the drain of a p-channel MOS transistor T14(x, y). Moreover, in each pixel G(x, y), the node between the transistors T1 and T2 is connected to the source of a p-channel MOS transistor T15(x, y) and to the source of a p-channel MOS transistor T16(x, y).

The sources of the transistors T13(2x−1, 2y−1), T13(2x−1, 2y), T13(2x, 2y−1), and T13(2x, 2y) and the drains of the transistors T15(2x−1, 2y−1), T15(2x−1, 2y), T15(2x, 2y−1), and T15(2x, 2y) are connected together. The gate of the transistor T13(x, y) is driven by the signal φS4. The gate of the transistor T15(2x−1, 2y−1) is driven by a signal φB4. The transistors T15(2x−1, 2y), T15(2x, 2y−1), and T15(2x, 2y) receive at their gates the high-level direct-current voltage VDD, and thus the transistors T15(2x−1, 2y), T15(2x, 2y−1), and T15(2x, 2y) are OFF all the time irrespective of the selected scan mode.

The sources of the transistors T14(2w−1, 2w−1), T14(2w−1, 2w), T14(2w−1, 2w+1), T14(2w−1, 2w+2), T14(2w, 2w−1), T14(2w, 2w), T14(2w, 2w+1), T14(2w, 2w+2), T14(2w+1, 2w−1), T14(2w+1, 2w), T14(2w+1, 2w+1), T14(2w+1 2w+2), T14(2w+2, 2w−1), T14(2w+2, 2w), T14(2w+2, 2w+1), T14(2w+2, 2w+2) and the drains of the transistors T16(2w−1, 2w−1), T16(2w−1, 2w), T16(2w−1, 2w+1), T16(2w−1, 2w+2), T16(2w, 2w−1), T16(2w, 2w), T16(2w, 2w+1), T16(2w, 2w+2), T16(2w+1, 2w−1), T16(2w+1, 2w), T16(2w+1, 2w+1), T16(2w+1, 2w+2), T16(2w−1) T16(2w+2, 2w), T16(2w+2, 2w+1), T16(2w+2, 2w+2) are connected together. Here, w represents an odd number. The gate of the transistor T14(x, y) is driven by the signal φS16. The gate of the transistor T16(4x−3, 4y−3) is driven by a signal φB16. The transistors T16(x, y) other than the transistor T16(4x−3, 4y−3) receive at their gates the high-level direct-current voltage VDD, and thus the transistors T16(x, y) other than the transistor T16(4x−3, 4y−3) are OFF all the time irrespective of the selected scan mode.

In the first scan mode, i.e., when the data of all the pixels are read out, a signal φPDDA (a signal that turns high when the photodiode PD needs to be disabled) is used as the signal φS1, while the signals φS4, φS16, φB4, and φB16 are kept high. Accordingly, the transistors T13(x, y), T14(x, y), T15(x, y) and T16(x, y) are OFF all the time, and the transistor T1 turns ON at readout. Thus, the photoelectric current occurring in each pixel G(x, y) is read out pixel by pixel.

In the second scan mode, i.e., when the data of the pixels that are located simultaneously in the odd-numbered rows and in the odd-numbered columns are read out, the signal φPDDA is used as the signal φS4, while the signals φS1, φS16, and φB16 are kept high, and the signal φB4 is kept low. Accordingly, the transistors T1, T15(x, y), and T16(x,y) are OFF all the time, the transistor T15(x, y) is ON all the time, and the transistor T13(x, y) turns ON at readout. Thus, the photoelectric currents occurring in four pixels (forming a two-by-two unit), namely G(2x−1, 2x−1), G(2x−1, 2x), G(2x, 2x−1), and G(2x, 2x), are added together in the pixel G(2x−1, 2x−1), and the sum is read out.

In the third scan mode, i.e., when the data of the pixels that are located simultaneously in the (4x-3)th rows and in the (4x-3)th columns are read out, the signal φPDDA is used as the signal φS16, while the signals φS1, φS4, and φB4 are kept high, and the signal φB16 is kept low. Accordingly, the transistors T1, T13(x, y), and T15(x, y) are OFF all the time, the transistor T16(x, y) is ON all the time, and the transistor T14(x, y) turns ON at readout. Thus, the photoelectric currents occurring in 16 pixels (forming a four-by-four unit), namely G(2w−1, 2w−1), G(2w−1, 2w), G(2w−1, 2w+1), G(2w−1, 2w+2), G(2w, 2w−1), G(2w, 2w), G(2w, 2w+1), G(2w, 2w+2), G(2w+1, 2w−1), G(2w+1, 2w), G(2w+1, 2w+1), G(2w+1, 2w+2), G(2w+2, 2w−1), G(2w+2, 2w), G(2w+2, 2w+1), and G(2w+2, 2w+2), are added together in the pixel G(2w−1, 2w−1), and the sum is read out. Here, w represents an odd number.

With any of the above-described circuit configurations for interconnection between pixels, when interlaced scanning is performed, the photoelectric currents occurring in the pixels that need to be scanned and the photoelectric currents occurring in the pixels that do not need to be scanned are added together. This helps prevent lowering of sensitivity in interlaced scanning.

As compared with the circuit configuration shown in FIG. 31, the circuit configurations shown in FIGS. 32 and 33 require a larger number of transistors, but improve circuit symmetry and thus make it very easy to produce a mask layout. Furthermore, the circuit configuration shown in FIG. 33 helps make the parasitic capacitance of the photodiode equal among pixels, and thus helps alleviate variations in low-brightness sensitivity in a case where the data of all the pixels are read out.

The embodiments described above deal with cases in which the present invention is applied to a scanning circuit used in an image-sensing apparatus. It is to be understood, however, that the present invention is applicable not only to scanning circuits used image-sensing apparatuses but also to other types of scanning circuits, for example those used in display apparatuses.

According to the present invention, interlaced scanning is achieved by, on one hand, feeding pulses as scanning signals to the input terminals of flip-flops belonging to a group corresponding to the photoelectric conversion elements that need to be scanned and, on the other hand, feeding a DC bias signal to the input terminals of flip-flops belonging to a group corresponding to the photoelectric conversion elements that do not need to be scanned so as to make those flip-flops active. In this way, interlaced scanning can be performed at the same scanning rate as when all photoelectric conversion elements are scanned without increasing the frequency of scanning pulses than when all photoelectric conversion elements are scanned.

Thus, according to the present invention, it is possible to achieve a higher scanning rate with scanning pulses having the same frequency, or achieve the same scanning rate with scanning pulses having a lower frequency.

Alternatively, according to the present invention, interlaced scanning is achieved by providing a plurality of shift registers having different numbers of stages and performing scanning by the use of one selected from among those shift registers. In this way, interlaced scanning can be performed at the same scanning rate as when all photoelectric conversion elements are scanned without increasing the frequency of scanning pulses than when all photoelectric conversion elements are scanned.

What is claimed is:

1. An image-sensing apparatus comprising:
a solid-state image-sensing device having a plurality of pixels arranged in a matrix, each pixel including a photoelectric conversion element, the solid-state image-sensing device having an adder circuit for adding together outputs of a plurality of pixels; and
a horizontal scanning circuit and a vertical scanning circuit for reading out signals from the individual pixels, operation of at least one of the horizontal and vertical scanning circuits being selectable between progressive scanning and interlaced scanning, one at a time among a plurality of units of stages that constitute said at least one of the scanning circuits outputting a select signal during interlaced scanning.

2. An image-sensing apparatus as claimed in claim 1, wherein the adder circuit adds together outputs of a plurality of pixels when said scanning circuit of which the operation is selectable between progressive scanning and interlaced scanning performs interlaced scanning.

3. An image-sensing apparatus as claimed in claim 1, wherein said scanning circuit of which the operation is selectable between progressive scanning and interlaced scanning comprises:
a shift register, said scanning circuit referring to outputs of individual stages of the shift register to scan corresponding pixels, the shift register being composed of a plurality of flip-flops, the plurality of flip-flops being classified into a plurality of groups, each flip-flop having an input terminal at which to receive a scanning signal, the flip-flops that belong to at least one of the plurality of groups receiving at the input terminals thereof selectively either a scanning pulse signal or a direct-current bias signal during a scanning period.

4. An image-sensing apparatus as claimed in claim 3, wherein said scanning circuit of which the operation is selectable between progressive scanning and interlaced scanning further comprises:
a logical operation circuit for performing, with respect to effective flip-flops that receive at the input terminal thereof a scanning pulse signal and that thus are involved in scanning, a logical operation between an output of each effective flip-flop and an output of an effective flip-flop provided in an immediately previous stage, said scanning circuit scanning pixels corresponding to the effective flip-flops according to a result of the logical operation.

5. An image-sensing apparatus as claimed in claim 1, wherein said scanning circuit of which the operation is selectable between progressive scanning and interlaced scanning comprises:
a first shift register composed of flip-flops provided one for each of the pixels to be scanned;
at least one second shift register composed of flip-flops provided one for each of pixels located at predetermined intervals among the pixels to be scanned; and
a selection circuit for selecting one of said first and at least one second shift registers, said scanning circuit scanning a plurality of pixels according to an output of the shift register selected by the selection circuit.

6. An image-sensing apparatus as claimed in claim 5, wherein said scanning circuit of which the operation is selectable between progressive scanning and interlaced scanning has a plurality of said second shift register, each second shift register being composed of flip-flops provided one for each of pixels located at different intervals.

7. An image-sensing apparatus as claimed in claim 1, wherein the adder circuit includes an output coupling switch for coupling together outputs of the photoelectric conversion elements of a plurality of pixels, the output coupling switch being turned on during interlaced scanning.

8. An image-sensing apparatus as claimed in claim 7, wherein each pixel comprises a photodiode and a photodiode cutoff switch for cutting off a pixel region located on a downstream side of the photodiode for a purpose of obtaining correction data for noise cancellation, the output coupling switch that is included in the adder circuit being connected immediately on a downstream side of the photodiode cutoff switch.

9. An image-sensing apparatus comprising:
a solid-state image-sensing device having a plurality of pixels, each pixel including a photoelectric conversion element; and
a scanning circuit for scanning the pixels, operation of the scanning circuit being selectable between progressive scanning and interlaced scanning, interlaced scanning being switchable between a first mode and a second mode that differ in number of lines skipped by interlacing.

10. An image-sensing apparatus as claimed in claim 9, wherein the scanning circuit comprises a shift register, the scanning circuit referring to outputs of individual stages of the shift register to scan corresponding pixels, the scanning circuit changing the number of skipped lines by controlling latch operation performed within individual units of the stages constituting the shift register.

11. An image-sensing apparatus as claimed in claim 9, wherein the scanning circuit comprises a plurality of shift registers each having units of a different number of stages, the scanning circuit changing the number of skipped lines by selecting one among the plurality of shift registers.

12. An image-sensing apparatus as claimed in claim 9, wherein the image-sensing device comprises:
an adder circuit for adding together outputs of a plurality of pixels, number of pixels of which the outputs the adder circuit adds together being variable.

13. An image-sensing apparatus as claimed in claim 12, wherein the adder circuit includes a first switch for coupling together outputs of a predetermined number of pixels to produce an output of a group of pixels and a second switch for coupling together outputs of a plurality of groups of pixels on a downstream side of the first switch.

14. An image-sensing apparatus as claimed in claim 12, wherein the adder circuit includes, for each group of pixels of which the outputs are to be coupled together, a first switch for coupling together outputs of a first predetermined number of pixels and a second switch for coupling together outputs of a second predetermined number, greater than the first predetermined number, of pixels.

15. An image-sensing apparatus as claimed in claim 14, wherein each pixel comprises a logarithmic conversion MOS transistor for converting the output of the photoelectric conversion element into an output proportional to an integral of amount of incident light, the adder circuit further including a third switch for connecting gates of the logarithmic conversion MOS transistors of a plurality of pixels of which the outputs are to be coupled together to an output of the plurality of pixels of which the outputs are so coupled together.

16. An image-sensing apparatus comprising:
a solid-state image-sensing device having a plurality of pixels arranged in a matrix, each pixel including a photoelectric conversion element; and
a scanning circuit for scanning the pixels, the scanning circuit performing scanning at a frequency equal to or higher than twice a scanning signal frequency, operation of the scanning circuit being selectable between progressive scanning and interlaced scanning, interlaced scanning being performed at a higher frame rate than progressive scanning or interlaced scanning being performed with a lower scanning pulse frequency than progressive scanning.

17. An image-sensing apparatus as claimed in claim 16, wherein the solid-state image-sensing device has an adder circuit for adding together outputs of a plurality of pixels.

18. An image-sensing apparatus as claimed in claim 16, wherein the scanning circuit comprises:
a shift register, said scanning circuit referring to outputs of individual stages of the shift register to scan corresponding pixels, the shift register being composed of a plurality of flip-flops, the plurality of flip-flops being classified into a plurality of groups, each flip-flop having an input terminal at which to receive a scanning signal, the flip-flops that belong to at least one of the plurality of groups receiving at the input terminals thereof selectively either a scanning pulse signal or a direct-current bias signal during a scanning period; and
a logical operation circuit for performing, with respect to effective flip-flops that receive at the input terminal thereof a scanning pulse signal and that thus are involved in scanning, a logical operation between an output of each effective flip-flop and an output of an effective flip-flop provided in an immediately previous stage, said scanning circuit scanning pixels corresponding to the effective flip-flops according to a result of the logical operation.

19. An image-sensing apparatus as claimed in claim 16, wherein the scanning circuit comprises:
a first shift register composed of flip-flops provided one for each of the pixels to be scanned;
at least one second shift register composed of flip-flops provided one for each of pixels located at predetermined intervals among the pixels to be scanned; and
a selection circuit for selecting one of said first and at least one second shift registers, said scanning circuit scanning a plurality of pixels according to an output of the shift register selected by the selection circuit.

20. An image-sensing apparatus as claimed in claim 19, wherein the scanning circuit has a plurality of said second shift register, each second shift register being composed of flip-flops provided one for each of pixels located at different intervals.
